(19) United States
(12) Patent Application Publication
(10) Pub. No.: US 2024/0021351 A1
(43) Pub. Date: Jan. 18, 2024

(54) ADJUSTMENT DEVICE, ADJUSTMENT SYSTEM AND COMPUTER PROGRAM PRODUCT

(71) Applicant: PHYSIK INSTRUMENTE (PI) GMBH & CO. KG, karisrunhe (DE)

(72) Inventor: Daniel GEISSLER, Baden-Baden (DE)

(21) Appl. No.: 18/026,053

(22) PCT Filed: Sep. 13, 2021
(86) PCT No.: PCT/EP2021/075120

§ 371 Date: Sep. 29, 2023

(30) Foreign Application Priority Data
Sep. 11, 2020 (DE) 102020123803.7

(51) Int. Cl. H01F 7/122; H01F 7/16; H01F 7/18

(52) U.S. Cl. CPC H01F 7/122; H01F 7/1646; H01F 7/1844

(57) ABSTRACT

Adjustment device, comprising: a base component (B1), an adjustment body (10), at least one flexure hinge (21), by means of which the adjustment body (10) is rotatably hinged on the base component (B1) about a flexure hinge rotation axis (D1), and at least one drive device (C), which is coupled to the base component (B1) and to an adjustment body connection device (AV), in order to move the same relative to each other, wherein the drive device (C) comprises an actor (60) which comprises an electrical coil (71) with a coil axis (AS) extending along the flexure hinge rotation axis (D1) and a compensation component (80) of a magnetizable or magnetized material and at least one permanent magnet segment (MS), which is disposed beside the actor (60) movably beside the same, wherein the magnet field lines in the interior of the permanent magnet segment (MS) extend along the coil axis (AS), and an adjustment system, an computer program product.

### FIELD OF INVENTION

The invention relates to an adjustment device, an adjustment system and a computer program product.

### BACKGROUND

U.S. Pat. No. 5,169,050 discloses an adjustment device with which movements of a wire bond head are generated by an actuator. The wire bond head is attached to a first end of a holder and the actuator is attached to a second end located opposite the first end. The holder is mounted on a carrier between the first and the second end by means of a flexure hinge. The actuator comprises a metallic sleeve in which two coils wound opposite one another are arranged. The axes of the coils extend concentrically to each other and concentric to the axis of the sleeve. The coils and the sleeve are attached to the carrier. A ferromagnetic magnet is arranged in the coils and is fastened to the second end of the holder. A current flow in the coils causes a displacement of the ferromagnetic magnet in the coils and thus a rotation of the holder with respect to the carrier. Due to a corresponding magnetization of the ferromagnet and the relative position of the ferromagnetic magnet in the coils, restoring forces of the structural joint are compensated.

An object of the invention is to provide an adjustment device which enables precise adjustment movements with a low energy consumption and is also advantageous in terms of production and assembly.

A further object of the invention is to provide an adjustment system and a computer program product with which an operating state of the adjustment device can be determined. These objects are achieved with the features of the independent claims. Further embodiments are specified in the dependent claims referring back to these claims.

### SUMMARY

According to the invention, an adjustment device is provided, which has: a base component, an adjustment body, at least one flexure hinge, by means of which the adjustment body is rotatably mounted on the base component about a flexure hinge rotation axis, and at least one drive device, which is coupled to the base component and, with the formation of a lever to the flexure hinge rotation axis, to an adjustment body connection device in order to move the adjustment body relative to the base component, for example in order to generate an actuating movement of the adjustment body along an adjustment path. In each embodiment of the invention, the drive device comprises:

an actuator which comprises an electrical coil and which comprises at least one compensation component made of a magnetizable or magnetized material, wherein the compensation component and the coil are mechanically fixed or fixable relative to one another, and at least one permanent magnet segment, which is in each case situated in a contactless distance in a direction extending in the coil axis beside the coil.

In all embodiments according to the invention, it can be provided that the electrical coil is assigned a coil axis which runs along the flexure hinge rotation axis. The coil axis of the coil can be defined herein in particular as a straight center line of gravity of the geometric shape of the coil. As an alternative to this definition of the coil axis, the coil axis can also be defined in such a way that it is identical in position and direction to the central curvature-free field line of the energized coil, which thus occurs in the case in which a voltage is applied to the coil and an electric current flows therein.

In all embodiments according to the invention, it can be provided that each of the at least one permanent magnet segment of a respective drive device is polarized in a direction in or along the coil axis AS when viewed from the adjustment body rotation axis D1.

In all embodiments according to the invention, the mounting of the drive device on the adjustment device can be provided for carrying out the adjustment movement according to one of the two alternatives (a), (b): (a) the actuator is coupled to the base component and the permanent magnet segment is coupled to the adjustment body connection device, (b) the actuator is coupled to the adjustment body connection device and the permanent magnet segment is coupled to the base component.

As a result, in all embodiments according to the invention, the at least one permanent magnet segment and the actor are arranged so as to be movable relative to one another, so that a relative movement direction is caused by this relative movement. The “relative movement direction” herein means in particular the or a direction of the relative movement between the coil and the permanent magnet segment upon actuation of a respective drive device. In all embodiments according to the invention, it can be provided that this relative movement direction runs transversely to a plane which is spanned by the flexure hinge rotation axis of the adjustment body and of the adjustment body connection device to which the respective actuator is coupled.

In this case, the coil axis of the coil can generally run in different directions, in particular along or transversely to the flexure hinge rotation axis.

The permanent magnet segment can generally be in particular a ferromagnetic segment herein.

In each of the embodiments of the adjustment device according to the invention

In each of the embodiments of the adjustment device according to the invention, the drive device can in particular be designed in such a way that at least one permanent magnet segment of the at least one permanent magnet segment and a portion of the coil at least partially overlap in a relative movement range of a movement of the at least one permanent magnet segment which causes a movement of the at least one permanent magnet segment and of the actor relative to one another, as seen in the coil axis.

Alternatively, each of the embodiments of the adjustment device according to the invention with the drive device can be designed in such a way that, in one and in particular the entire relative movement range of the relative movement between the at least one permanent magnet segment and the actor, which causes an adjustment movement of the drive device, viewed in the coil axis, at least one permanent magnet segment of the at least one permanent magnet segment and a section of the coil do not overlap, but their outer circumferences approach up to a minimum distance. The minimum distance can in particular result from an amount which is determined from the diameter of the coil multiplied by a factor which can lie in particular in a range of values of 0.001 and 0.75.

Alternatively or in addition to the embodiments of the adjustment device according to the invention, to which an overlap or a minimum distance is defined with respect to the limits of the relative movement between the at least one permanent magnet segment and the actor, it can be defined that in this relative movement region the compensation component can be moved between two positions relative to the permanent magnet segment between which the magnetic interaction between the permanent magnet segment and the compensation component changes.

In each of the embodiments of the adjustment device according to the invention, in particular the drive device can be designed in such a way that, when viewed in a first relative movement state, when viewed in the coil axis, the at least one compensation component is situated outside one of the at least one permanent magnet segment and, in a second relative movement state, the same compensation component and the same permanent magnet segment overlap or at least partially or completely overlap. In this case, it can be provided in particular that in this second relative movement state the same compensation component and the same permanent magnet segment completely overlap or completely cover. The first relative movement state can in particular be a predetermined reference state.

In embodiments of the adjustment device with an arrangement of a pair of permanent magnet segments, that is to say of a first permanent magnet segment and a second permanent magnet segment, on a first side of the coil, optionally additionally a further pair of permanent magnet segments, which is situated on a second side of the coil, which is situated opposite the first side with respect to the coil, comprising a further first permanent magnet segment which, when viewed in the coil axis, is located at the same height as the first permanent magnet segment, and a further second permanent magnet segment, which, when viewed in the coil axis, is located at the same height as the second permanent magnet segment, can be provided in such a way that the following relative movement states can be set:

a first relative movement state, which may in particular be the reference state, in which, as seen in the coil axis, each of the at least one compensation component can be situated outside each of the permanent magnet segments or, alternatively, each of the at least one compensation component at least partially covers the at least one permanent magnet segment of the one pair of permanent magnet segments or of the two pairs of permanent magnet segments,

a second relative movement state, in which the first permanent magnet segment and optionally the further first permanent magnet segment, which, when viewed in the coil axis, is arranged at the same height as the first permanent magnet segment, has approached the aforementioned minimum distance, or in which an at least partial overlap between one of the at least one compensation component and the first permanent magnet segment and optionally the further first permanent magnet segment takes place,

a third relative movement state, in which the second permanent magnet segment and optionally the further second permanent magnet segment, which is, when viewed in the coil axis, respectively arranged at the same height as the second permanent magnet segment, has approached the aforementioned minimum distance, or in which an at least partial overlap between one of the at least one compensation component and the second permanent magnet segment and optionally the further second permanent magnet segment takes place.

In this regard, in particular, the second relative movement state and the third relative movement state can be, in relation to the coil axis, opposite extreme positions of the relative movement between the coil and the respective permanent magnet segment.

In embodiments of the adjustment device with an arrangement of at least one pair of permanent magnet segments, provision can be made for producing a holding force compensating the restoring force in the second relative movement state and in the third relative movement state, which holding force is in particular at least 0.1%, preferably at least 50%, and particularly preferably at least 80% of the restoring force which arises in the respective instantaneous position of the relative movement between the coil and the respective permanent magnet segment of the flexure hinge. In a particularly optimized adjustment device according to the invention in this respect, the holding force compensating the restoring force can also be at least 90% or even at least 95% of the restoring force.

In embodiments of the adjustment device according to the invention, in which at least one drive device comprises only a first and optionally a further first permanent magnet segment, it can be provided that the first relative movement state, which can in particular be the reference state, and the second relative movement state are the extreme positions of the relative movement between the coil and the respective permanent magnet segment which are opposite to one another with respect to the coil axis. In this case, it can in particular be provided that the coil axis runs along the flexure hinge rotation axis. As an alternative to this, it can be provided that the relative movement direction of the relative movement between the coil and the permanent magnet segment extends transversely to a plane which is spanned by the flexure hinge rotation axis of the adjustment body and of the adjustment body connection device on which the respective actor is coupled. In this case, it can also be provided that the coil axis runs transversely to the flexure hinge rotation axis.

In embodiments of the adjustment device according to the invention, in which at least one drive device comprises only a second and optionally a further second permanent magnet segment, it can be provided that the first relative movement state, which may in particular be the reference state, and the third relative movement state are the extreme positions of the relative movement between the coil and the respective ferromagnetic segment that are opposite to one another with respect to the coil axis.

In each of the embodiments of the adjustment device according to the invention, provision can be made for the compensation component to be adjustable in at least one drive device by means of an adjustment mechanism of the drive device in a relative position within an adjustment range relative to the coil or to the coil housing. With the adjustment mechanism, the compensation component can be fixed relative to the coil or to the coil housing in this adjusted relative position within the adjustment range by means of a fixing device of the adjustment mechanism. By adapting a relative position, in particular the adjustment region of the actor, in which the restoring force of the at least one flexure hinge is completely or partially compensated, can be adapted and optimized within the entire adjustment range in the individual case. In this case, it can be provided in particular that the adjustment range extends over a maximum of 50% of the average diameter of the coil transversely to the coil axis AS.

Each of the at least one adjustment body connection device is situated at a distance from the adjustment body rotation axis, wherein it can be provided that, the distance is at least one tenth of the smallest diameter of the coil.

According to one embodiment of the invention, an adjustment device is provided, which comprises: a base component, an adjustment body, at least one flexure hinge, by means of which the adjustment body is rotatably mounted on the base component about a flexure hinge rotation axis, a drive device which comprises an actor and which is coupled to the base component and to an adjustment body connection device with forming a lever with respect to the flexure hinge rotation axis and which is realized according to one of the variants defined herein. According to a further embodiment of the adjustment device according to the invention, said adjustment device comprises two or more than two drive devices, which are coupled to the base component and to a respective adjustment body connection device, wherein each drive device is coupled to the base component and to an adjustment body connection device. In this case, it can be provided that two drive devices are each coupled to the adjustment body by means of an adjustment body connection device, wherein the adjustment body connection devices are arranged opposite one another with respect to the flexure hinge rotation axis. In this case, two drive devices can be arranged opposite one another with respect to the flexure hinge rotation axis. In each of the mentioned embodiments of the adjustment device, a plurality of adjustment body connection devices can also be arranged on the same side of the adjustment body with respect to the flexure hinge rotation axis.

The coupling of a drive device to the base component preferably takes place at a region of the base component, which is situated in the region of the respective adjustment body connection device or in an angular range of at most 85 degrees and preferably of a maximum of 45 degrees in both circumferential directions, as seen from the center of the adjustment body. In general, the coupling of a drive device to the base component can be arranged on any region of the base component.

The adjustment device comprises at least one compensation component made of a magnetizable or magnetized material. The compensation component is preferably arranged outside a section of the coil as seen in the coil axis. In particular, in each of the embodiments of the adjustment device, the arrangement of the at least one compensation component can be provided in each case according to one or both of the following alternatives (K1), (K2): (K1), as seen in the coil axis, in the outer space surrounded by the inner circumference of the coil or, in the case of an at least partially hollow-ring-shaped coil housing, in the outer space surrounded by the hollow-ring-shaped coil housing; (K2), as seen in the coil axis, in the outer space located outside the outer circumference of the coil or, in the case of an at least partially hollow-ring-shaped coil housing, in the outer space located outside the outer circumference of the hollow-ring-shaped coil housing.

In particular, in each embodiment of the adjustment device or actor according to the invention, at least one compensation component can be designed and arranged in such a way that at least in a section of the movement range of the at least one permanent magnet segment elative to the actor, viewed in the coil axis, a permanent magnet segment of the at least one permanent magnet segment overlaps or at least partially overlaps a section of the coil or the same approach themselves up to the aforementioned minimum distance. In these cases, but independently thereof, provision can be made for the respective drive device to generate a holding force compensating the restoring force, which holding force is in particular at least 0.1% and in this case specifically at least 1%, preferably at least 50%, and particularly preferred at least 80% of the restoring force, which is produced in the respective instantaneous position of the relative movement between the coil and the respective permanent magnet segment by the flexure hinge. In a particularly optimized adjustment device according to the invention in this respect, which is specifically optimized in this regard, the holding force compensating the restoring force can also be at least 90% or even 95% of the restoring force.

The overlap or at least sectionally overlap can in particular also be realized in the reference state.

In particular, the “reference state” can be referred to herein as the zero position or an adjustment state or output state of the actuator. Alternatively or additionally, the “reference state” can be understood to mean, in particular, the adjustment state of the actor in which no current flows in the coil.

In the adjustment device according to the invention, in the aforementioned section of the movement range or in particular in the aforementioned overlap region or when approaching in particular up to the minimum distance of the relative movement between the coil and the respective one of the at least one permanent magnet segment due to the magnetic interaction, a holding force is produced between the respective one of the at least one permanent magnet segment and the at least one compensation component with which compensation of the restoring force or the corresponding restoring moment caused by the deflection of the flexure hinge takes place. The holding force compensating the restoring force can be in particular at least 0.1% and in this case specifically at least 1%, preferably at least 50%, and particularly preferably at least 80% of the restoring force. The compensating holding force results in that the at least one compensation component, in the case of a deflected position of the adjustment body, comes at least in the vicinity of a permanent magnet segment—optionally with the minimum distance—or else is situated beside a permanent magnet segment with partial overlap. The previously described magnetic interaction between at least one permanent magnet segment and the at least one compensation component acts on the restoring force or the restoring moment of the flexure hinge due to its deflection or elastic deformation.

In all embodiments of the drive device according to the invention, the distance between the at least one permanent magnet segment and the coil can be very small, as seen from the adjustment body rotation axis or the center of the adjustment body, so that there is a residual air gap between them. As a result, the holding force or compensation force can be optimized and optionally increased.

In the embodiments of the adjustment device according to the invention with an arrangement of a pair of permanent magnet segments and optionally additionally a further pair of permanent magnet segments, which is situated on a second side of the coil, which is situated opposite the first side with respect to the coil, the permanent magnet segments can have identical shapes, each of which particularly, when seen in the coil axis, are defined by means of which peripheral lines bordering the respective outer circumference. In general, it can be provided that the surfaces of the permanent magnet segments, in each case of a pair of permanent magnet segments, facing the coil each extend along or in the direction of a straight plane in which the center Z of the adjustment body and the coil axis are situated.

In the embodiments of the adjustment device according to the invention, it can in particular be provided that the orientation of the permanent magnet segments in each case of a pair of permanent magnet segments or of each pair of permanent magnet segments, viewed in the coil axis, are identical. These orientations are referred to herein as “base segment orientation”.

Alternatively, it can be provided that the orientation of the permanent magnet segments in each case of a pair of permanent magnet segments or of each pair of permanent magnet segments in the coil axis, as seen in the coil axis, relative to the aforementioned identical orientation of the same, are rotated about an angular range. In this case, it can be provided that the rotation of each permanent magnet segment of a respective pair takes place in one direction, in which an extension of a line of the surface thereof facing the coil, which extends in the base segment orientation in the direction of the extension of the straight plane, in which the center Z of the adjustment body and the coil axis are situated, is moved on the side of the center of the adjustment body in direction to the center. In this case, the rotation axis can in particular take place about the coil. The amount of rotation from the base segment orientation may be in a range between 0.1 degrees and 60 degrees.

By means of this rotation of the permanent magnet segments of a pair of the same relative to their respective base segment orientation, it can be achieved that the effectiveness of the adjustment device is optimized with larger actuating movements of the adjustment body. In particular, a linearity or approximate linearity of the change in the holding force or the compensation force can also be achieved as a function of the adjustment angle of the adjustment body.

In all embodiments of the drive device, however, it can also be realized in such a way that no overlap or no at least partial overlap of the compensation component and one of the at least one permanent magnet segment in the coil axis is possible and not performed in the movement range of the relative movement between the coil and the at least one permanent magnet segment. In these embodiments, a compensation force or a compensation force, which is essential to the compensation of the restoring force, is generated from a predetermined maximum distance of an edge point of the outer circumference of the compensation component and of a closest edge point of the respective one of the at least one permanent magnet segment. In this case, it can also be provided that the compensation force increases when this maximum distance decreases as the edge points continue to approach one another.

In the embodiments of the drive device in which an overlap or at least partial overlap of the coil and the at least one permanent magnet segment can be realized, the respective drive device can also be designed in such a way that the restoring force is partially or completely compensated for already at such a predetermined maximum distance and not only when an adjustment state of the adjustment device is reached in which an overlap or at least partial overlap of the coil and of the at least one permanent magnet segment is provided.

In all embodiments, it can also be provided that the compensation of the restoring force takes place only partially, i.e. that only a fraction of the restoring force is compensated for by the holding force between at least one permanent magnet segment and the at least one compensation component, so that the restoring force is not completely compensated, but only partially compensated.

As an alternative or in addition to the aforementioned design and arrangement of the compensation component, in each embodiment of the adjustment device or actuator according to the invention, at least one compensation component can be designed and arranged in such a way that, as seen in the coil axis, at least in a section of the movement range of the at least one permanent magnet segment relative to the actor, the compensation component is arranged at least in sections in the field line region of a permanent magnet segment.

As an alternative to the aforementioned configurations and arrangements of the compensation component or additionally, in each embodiment of the adjustment device or actuator according to the invention, at least one compensation component can be designed and arranged in such a way that, as seen in the coil axis, a section of the coil extends at least partially within the permanent magnet segment in a reference state of the respective drive device or of the adjustment device and in this case optionally a permanent magnet segment and the at least one compensation component do not at least partially cover when viewed in the coil axis, and at least one permanent magnet segment and the compensation component overlap or partially cover or completely cover in a state of the adjustment device adjusted from the reference state.

In the embodiments of the adjustment device according to the invention, in combination with otherwise each of the variants of the adjustment device described herein, it can be provided that the adjustment device comprises a second chive device, so that the adjustment device comprises a first drive device and a second drive device, each of which is coupled to an adjustment body connection device of the actuator, wherein the connection devices are symmetrically opposite with respect to the flexure hinge rotation axis.

In the embodiments of the adjustment device according to the invention, in combination with otherwise any variants of the adjustment device described herein, it can be provided that the adjustment device comprises an at least sectionally hollow-ring-shaped coil housing in which the coil is arranged, wherein the circumferential direction of the coil runs along the circumferential direction of the coil housing. In such embodiments of the adjustment device according to the invention, it can be provided that at least one compensation component, as seen in the coil axis, is arranged in the outer space which is surrounded by the coil housing. Furthermore, in such embodiments of the adjustment device according to the invention, it can be provided that the compensation component is arranged in the outer space located outside the outer circumference of the coil housing as seen in the coil axis

In such embodiments of the adjustment device according to the invention, it can be provided that at least one drive device comprises at least one arrangement of two permanent magnet segments which, viewed from the center Z, are arranged on at least one side of the coil, and a compensation component, which comprises at least one side surface, which in each case faces an arrangement of the permanent magnet segments, wherein the side surface comprises two straight-surface partial surface portions, the orientations of which extend at an angle between 10 degrees and 40 degrees with respect to the coil axis, wherein the angles in the zero position or in the reference state, viewed from the center Z, open in one direction in which the respectively closer permanent magnet segment of the arrangement of permanent magnet segments is situated.

In the embodiments of the adjustment device according to the invention, in combination with otherwise any variants of the adjustment device described herein, provision can be made for at least one drive device to comprise in each case two permanent magnet segments which are fastened on a magnetic segment support, wherein the permanent magnet segments are located on the same side of the actuator as seen from the adjustment body rotation axis and are arranged one behind the other in the direction of the relative movement of the permanent magnet segments with respect to the coil.

In all embodiments of the adjustment device according to the invention with at least one drive device with an arrangement of two permanent magnet segments, which is arranged on one of the two opposite sides of the coil as seen from the center Z of the adjustment body, the at least one compensation component can each comprise a side surface facing the arrangement of the permanent magnet segments which comprises two, in particular straight-surfaced or spherically curved partial surface portions, the orientations of which extend at an angle between 10 degrees and 40 degrees with respect to the coil axis, wherein the angles in the zero position or in the reference state, viewed from the center Z, open in a direction in which the respectively closer permanent magnet segment of the arrangement of permanent magnet segments is located.

In the embodiments of the adjustment device according to the invention, in particular in combination with otherwise any variant of the adjustment device described herein, it can be provided that a drive device comprises in each case two pairs of permanent magnet segments, and a first pair of permanent magnet segments is arranged on a first magnetic segment support and a second pair of permanent magnet segments is arranged on a second magnetic segment support, wherein the pairs of permanent magnet segments are located on opposite sides of the actuator as seen from the adjustment body rotation axis.

In all embodiments of the adjustment device according to the invention with at least one drive device with two arrangements of two permanent magnet segments, each of which is arranged on the opposite sides of the coil as seen from the center Z or from the adjustment body rotation axis, the at least one compensation component can each comprise two side faces which, when viewed from the adjustment body rotation axis, are situated on sides of the compensation component that are lying opposite one another, wherein each of which is situated facing an arrangement of the permanent magnet segments. In this case, each of the side surfaces can comprise two, in particular straight-surfaced or spherically curved partial surface portions, the orientations of which are aligned with an angle between 10 degrees and 40 degrees with respect to the coil axis, wherein the angles in the zero position or in the reference state, viewed from the center Z, open in a direction in which the respectively closer permanent magnet segment of the arrangement of permanent magnet segments is situated.

In embodiments of the adjustment device according to the invention, in which at least one drive device comprises only one permanent magnet segment located on a first side of the coil and optionally a further permanent magnet segment arranged on a second side of the coil, which is situated opposite the first side with respect to the coil, and which, as seen in the coil axis, at the same height as the permanent magnet segment located on the first side of the coil, the at least one compensation component can each comprise a side surface facing the respective permanent magnet segment, which comprises an in particular straight-surfaced or spherically curved partial surface portion, the orientations of which extend at an angle between 10 degrees and 40 degrees with respect to the coil axis, wherein the angles in the zero position or in the reference state, viewed from the center Z, open in a direction in which the respective permanent magnet segment is situated.

In the embodiments of the adjustment device according to the invention, in combination with otherwise any variants of the adjustment device described herein, it can be provided that the adjustment device comprises at least one or more of the sensors (8a), (8b), (8c): (8a) a current meter that detects the current in the coil, (8b) a rotation angle sensor which, in the flexure hinge device or in one of the flexure hinges, detects a rotation for determining a rotational movement of the adjustment body relative to the base component B1, (8c) a magnetic field sensor arranged in the actuator, which detects the strength and the direction or the thickness or the direction of the magnetic field in the space surrounding the coil, wherein the adjustment device comprises a data management device, which is functionally connected to the at least one respective sensor according to (8a), (8b), (8c) and comprises: an interface function, with which signals which are detected by the at least one sensor are received and converted to storable sensor data and stored, and a transmission function, by means of which the sensor data are transmitted to a receiving device of an evaluation device.

According to a further aspect of the invention, an adjustment system which comprises an adjustment device according to an embodiment described herein is provided with the current meter, the rotation angle sensor, the magnetic field sensor and the evaluation device, wherein the evaluation device comprises: a receiving function which receives the sensor data from the transmission function, an evaluation function which assigns an operating state value for the adjustment device from the sensor data.

In such an adjustment system, it can be provided according to the invention that the evaluation function comprises a maintenance function which compares a plurality of sensor data with at least one setpoint value and, if the setpoint value is exceeded or undershot, generates the operating state value

In the embodiments of the adjustment system according to the invention, in combination with otherwise any variants of the adjustment system described herein, it can be provided that the evaluation device comprises a display device which is functionally connected to the evaluation function and displays the operating state value.

In the embodiments of the adjustment system according to the invention, in combination with otherwise any variants of the adjustment system described herein, it can be provided that the evaluation function determines at least one operating state value which indicates one or more of the following operating states of the adjustment device on the display device: (Z1) the adjustment device is in normal operation; (Z3) the adjustment device is defective; (Z3) for the adjustment device, a maintenance measure or safety check is due.

In the embodiments of the adjustment system according to the invention, in combination with otherwise any variants of the adjustment system described herein, it can be provided that the evaluation function comprises a simulation function with a mathematical model of the adjustment device and with a transfer function, wherein the transfer function supplies a plurality of sensor data to the mathematical model and the mathematical model from the sensor data determines control state values of one or more of the following components: (T1) the drive device, (T2) of the adjustment body.

According to a further aspect of the invention, a computer program product is provided, which is designed to generate a digital image of an embodiment of the adjustment device according to the invention or of an embodiment of the adjustment system according to the invention.

According to a further aspect of the invention, a computer program product is provided which comprises an evaluation function which assigns an operating state value for the adjustment device from sensor data determined in the adjustment device,

wherein the evaluation function comprises a simulation function with a mathematical model of an embodiment of the adjustment device according to the invention and with a transfer function, wherein the transfer function supplies a plurality of sensor data to the mathematical model and the mathematical model from the sensor data determines control state values of a plurality of the following components: (T1) of the drive device, (T2) of the adjustment body.

In each computer program product according to the invention, the mathematical model of the adjustment device can be designed in such a way that it determines control state values of one or more of the following components on the basis of at least one input value for an electrical input signal for the coil: (T1) of the drive device, (T2) of the adjustment body.

In each computer program product according to the invention, the mathematical model of the adjustment device can be designed in such a way that the mathematical model of the adjustment device determines control state values of the adjustment body with the rotation of the adjustment body about the adjustment body rotation axis relative to the base component with a functional inclusion of the dynamic behavior of the flexure hinge on the basis of actuation values of the drive device.

In each computer program product according to the invention, the mathematical model of the adjustment device can be designed in such a way that the mathematical model of the adjustment device comprises a drive device model which determines adjustment state values of the drive device on the basis of at least one input value for an input signal for the coil.

In each computer program product according to the invention, the mathematical model of the adjustment device can be designed in such a way that the drive device model functionally defines the magnetic interaction of the coil, the compensation component and the permanent magnet segment on the basis of input values for an input signal for the coil.

An electrical input signal activates the coil and generates a corresponding magnetic field.

In general, the simulation model determines the dynamic behavior of the actuator or control state values of the actuator as a function of an electrical input signal for the coil. The electrical input signal can be defined in particular by: (E1) an electric current flowing in the coil, (E2) a voltage applied to the coil, (E3) a tune profile of an electric current flowing in the coil, (E4) a time profile of a voltage applied to the coil, (E5) a combination of the alternatives (E1) to (E4).

In this regard, each of the embodiments of the actuator may comprise a control device which is connected to the coil and which, upon activation thereof, causes an input signal for the coil and, in particular, an electric current flowing in the coil.

Generally, herein, the operating state value or adjustment state value of the drive device may be defined: (E6) an adjustment path of at least one permanent magnet segment, (E7) a relative movement distance between at least one permanent magnet segment and the coil axis, (E8) an adjustment path of a connection device assigned to the respective drive device, (E9) a combination of several of the alternatives (E6) to (E8).

In general, the adjustment state values of the adjustment body can be defined herein: (E10) a rotational position of the adjustment body, (E11) a rotational speed of the adjustment body, (E12) a combination of several of the alternatives (E10) to (E11).

Here, the expression “magnetized” in relation to a compensation component means that the compensation component has been magnetized in a specific manner before installation into the respective adjustment device or before the start of an actuation of a respective drive device, for example in the production of the compensation component.

Herein, the term “magnetizable” with respect to a compensation component means that the compensation component is magnetized in a specific manner under the action of an external magnetic field. In particular, the expression “magnetizable” in relation to a compensation component means that, in a state in which the same is installed in the adjustment device, under the action of a permanent magnet segment it is put into a magnetic state which has a proportion of the generation of the holding force. Furthermore, in particular the expression “magnetizable” in relation to a compensation component can mean that this has not been magnetized in a specific manner before installation in the respective adjustment device, for example in the production of the compensation component.

The material of a magnetized compensation component and the material of a magnetizable compensation component can in each case be formed from a soft-magnetic material or consist of a soft-magnetic material.

The material of a magnetized compensation component can be formed from a hard magnetic material or consist of a hard magnetic material.

The term “soft-magnetic” is used for materials that cannot be magnetized permanently. Due to their high magnetic permeability, however, a force acting on the element consisting of a soft magnetic material can be achieved by changing the position of the corresponding element in an external magnetic field.

The term “hard magnetic” is used for materials which, after being magnetized, retain a permanent inner magnetic field. By means of this inner magnetic field, a force effect due to the principle of energy minimization can be achieved with interaction with an external magnetic field

According to the invention, a compensation component, when formed from a soft-magnetic material, can be formed, in particular, from the following materials: (w1) The soft magnetic material is based on a metal, which in particular comprises the ferromagnetic metals and in this case specifically one or more of the following metals: iron, cobalt or nickel. In this case, the soft-magnetic material can comprise a crystalline alloy, an amorphous alloy or a nanocrystalline alloy. (w2) The soft-magnetic material is formed from a ceramic material and in particular a ferrite, (w3) The soft magnetic material is formed from a combination of materials or substances mentioned in (w1) and (w2).

The term “relative movement direction” herein means in particular the or a direction of the relative movement between the coil and the permanent magnet segment upon actuation of a respective drive device.

The expression “along” means herein in the context of a directional indication mentioned herein, which in particular can also relate to the course of a contour line or of a surface or a direction of a component or a structural component such as an axis or a shaft or a central axis thereof, with respect to a reference direction or a reference axis, that a portion of the course or the tangent to a respective contour line or respective surface or the direction in an explicitly or implicitly predetermined viewing direction locally or in sections at an angle of a maximum of 45 degrees and in particular of a maximum of 30 degrees of the respective reference direction or reference axis, to which the respective direction indication is related.

The term “transverse” herein means in the context of a directional indication referred to herein, which in particular can also relate to the course of a contour line or a surface or a direction of a component or a structural component such as an axis or a shaft or a central axis thereof with respect to a reference direction or a reference axis that a portion of the course or the tangent to a respective contour line or respective surface or the direction in an explicitly or implicitly predetermined viewing direction differs locally or in sections at an angle which is between 45 degrees and 135 degrees, and preferably at an angle which is between 67 degrees and 111 degrees, from the respective reference direction or reference axis, to which the respective directional indication is related.

The term “distance” in particular between two surfaces is understood here in particular as the shortest distance.

A “longitudinal direction” or another reference direction of a reference line, such as in particular a central axis or a centrally extending line or a center line of at least one structural component or of a component, and in particular of a guide track or guide component during a relative movement, is obtained herein in particular as a connecting line of the centroid points of the respectively smallest cross-sectional areas of the respective structural component along a determined or predetermined direction such as, for example, the relative movement or between two determined or predetermined ends, which can result from the relative movement. In the case that the reference line can run in a curved or at least partially curved manner, the reference direction can generally be understood as a local longitudinal direction. Here, however, the reference direction herein can also be understood as the direction of a straight-line defined reference line, wherein, in order to determine the straight reference line from a curved line, a line is used, the position of which relative to the curved line in the course within the respective structural component in the sum results in the smallest deviation between these lines or the smallest deviation area. The same is applicable if a straight reference line is to be derived from a curved line herein.

The term “center” with respect to a component or a component is understood herein to mean, in particular, the center of mass or the geometric center of gravity of the component or of the component. For the adjustment body, the center can in particular be the centre point of the length of the adjustment body rotation axis with which it extends through the adjustment body or the adjustment body frame.

For an actuation of the adjustment device according to the invention, the coil of an actuator is electrically controlled so that it generates a magnetic field. The magnetic center of the magnetic field located in the interior or interior of the coil or its central field line in the interior of the coil is defined herein as a coil axis AS.

In particular, the term “substantially” in relation to a value or a ratio is understood herein to mean that the feature contains a deviation of 20% and especially of 10% of the feature or its geometric property or value.

The term “substantially” with respect to a comparison of a shape or a shape of a component with a reference indication, e.g., rectangular, means that the line or shape matches the reference indication in sections. For example, “substantially rectangular” may mean that individual or all sections, which comprise corners of the right-hand corner, are configured as rounded sections.

By a “curved course” of a line or edge or surface is meant that the surface comprises no corner, as seen along a reference direction, over the entire width extending transversely to the reference direction, i.e. comprises a differentiable profile.

“Orientation” with respect to a surface and in particular surface is understood herein to mean the normal to the respective surface. In the event that the surface in question is not a straight but, for example, a curved surface, the normal to a straight surface of the same size can be used to determine the surface normal, for the position of which the smallest deviation results in the sum relative to the curved surface.

An “extension” of a surface portion is understood to mean a direction of a planar surface portion which runs along the surface portion which is referred to and comprises such a orientation with respect thereto, in which the sum of the deviation amounts between the two surface sections are minimal. With respect to a length amount of the extent of a surface portion, a length of a fictitious surface portion of the same size is understood herein in a direction to be defined which comprises a position relative to the referenced surface portion, in which the sum of the deviation amounts between the two surface portions is minimal.

The term “in one piece” with respect to a component or a component is understood herein to mean that the component or component is produced as one piece. in this case, the component or the component can be formed from a plurality of pieces or parts which are connected to one another or are connected to one another. In this regard, the term “produced from one piece” is understood to mean that the component or the component is produced from an one-piece starting workpiece during its production.

“Position” of a part or of a component can be understood here in particular to mean the position of the center of mass or of the geometric center of gravity of the respective part or of the respective component.

The term “hollow ring” is understood here to mean a circumferentially closed component which, with its outer surfaces, surrounds an outer space and is hollow in the interior, i.e., delimits with its inner surface a ring-shaped space. A component designed as a hollow ring can be designed as a shell. In a viewing direction from the side to the hollow ring component, it can be circular or in another form. The shape of the ring can be described by the course of the center line of the interior space bounded by the hollow ring. For example, the hollow ring can be shaped in such a way that its interior center line runs substantially rectangular. The term “ring” in this context means merely that the hollow ring is circumferentially closed, but does not define any further property of the hollow ring.

A “overlap of a permanent magnet segment and a respectively affected portion of the coil” or a “distance between a permanent magnet segment and a portion of the coil” herein respectively relates to the outer circumference of the respective permanent magnet segment and the outer circumference of the coil or the outer circumference of a portion of the coil and in each case results in a viewing direction in the direction of the coil axis AS. Here, the overlapping means partially covering a respective permanent magnet segment and a respectively affected section of the coil.

In the following, embodiments of the invention are described with reference to the accompanying figures. Herein, the description of features or components of embodiments according to the invention is to be understood as meaning that a particular embodiment according to the invention, provided that this is not explicitly excluded, can also comprise at least one feature of another embodiment, in each case as an additional feature of this specific embodiment or as an alternative feature which replaces another feature of this specific embodiment.

### DESCRIPTION OF DRAWINGS

The figures show:

FIG. 1 shows a perspective illustration of an embodiment of the adjustment device according to the invention comprising a base component in the form of an adjustment body housing, an adjustment body which is rotatably mounted on the adjustment body housing by means of a flexure hinge device, and two drive devices for adjusting the adjustment body, wherein each drive device comprises an actor with a hollow-ring-shaped coil housing, in which a coil extends in its circumferential direction and with a compensation component and an arrangement of ferromagnetic segments that can be moved relative to the actor,

FIG. 2 shows a further perspective illustration of the embodiment of the drive device according to the invention shown in FIG. 1, wherein the drive device is partially cut open,

FIG. 3 shows a perspective illustration of the combination of the adjustment body with two arrangements of magnet segments fastened thereto for forming in each case one drive device,

FIG. 4 shows a perspective illustration of a variant of a drive device for integration into an embodiment of the adjustment device according to the invention, wherein the drive device is shown in a reference state or an initial position,

FIG. 5 shows the variant of a drive device according to FIG. 4 in a perspective illustration, wherein the drive device is shown in a first adjustment state,

FIG. 6 shows the variant of a drive device according to FIG. 4 in a perspective illustration, wherein the drive device is shown in a second adjustment state,

FIG. 7 shows a schematic side view of the coil of an embodiment of the drive device of the adjustment device according to the invention with lines for defining the shape of the coil housing with the coil, wherein the drive device is formed according to FIGS. 4 to 6 and wherein the drive device is in a reference state or a zero position,

FIG. 8 shows a perspective illustration of the adjustment body and permanent magnet segments fastened laterally thereto of an embodiment of the adjustment device according to the invention,

FIG. 9 shows an exploded view of a drive device with a variant of the compensation component,

FIG. 10 shows a perspective illustration of the drive device according to FIG. 9,

FIG. 11 shows a perspective illustration of a variant of the actor for integration into an embodiment of the adjustment device according to the invention,

FIG. 12 shows an exploded view of the variant of the actor of FIG. 11,

FIG. 13 shows an exploded view of a variant of the drive device with the variant of the actor of FIG. 11 or FIG. 12,

FIG. 14 is a perspective view of the components of the drive device of FIG. 13,

FIG. 15 shows an exploded view of a drive device with a variant of the compensation component,

FIG. 16 shows a perspective illustration of the drive device according to FIG. 15,

FIG. 17 shows an exploded view of a drive device with two compensation components in a special embodiment,

FIG. 18 shows a perspective illustration of the drive device according to FIG. 17,

FIG. 19 shows a schematic sectional view of the embodiment of the drive device of FIG. 13, wherein the compensation component is formed from a soft magnetic material and the drive device comprises two pairs of permanent magnet segments, wherein the drive device is shown in a reference state with simultaneous representation of calculated or simulated magnetic Field lines,

FIG. 20 shows the embodiment of the drive device of FIG. 19 in the sectional illustration shown therein, wherein the drive device is shown in a first adjustment state or relative movement state with simultaneous representation of calculated or simulated magnetic field lines,

FIG. 21 shows the embodiment of the drive device of FIG. 19 in the sectional illustration shown therein, wherein the drive device is shown in a second adjustment state or relative movement state with simultaneous representation of calculated or simulated magnetic field lines,

FIG. 22 shows an exploded view of a variant of the drive device with the actuator according to FIGS. 11 and 12,

FIG. 23 shows a schematic sectional view of an embodiment of the drive device of FIG. 22, wherein the compensation component is formed from a hard magnetic material and the drive device comprises two pairs of permanent magnet segments, wherein the drive device is shown in a reference state with simultaneous representation of calculated or simulated magnetic field lines,

FIG. 24 shows the embodiment of the drive device of FIG. 23 in the sectional illustration shown therein, wherein the drive device is shown in a first adjustment state or relative movement state with simultaneous representation of calculated or simulated magnetic field lines,

FIG. 25 shows the embodiment of the drive device of FIG. 23 in the sectional illustration shown therein, wherein the drive device is shown in a second adjustment state or relative movement state with simultaneous representation of calculated or simulated magnetic field lines.

FIG. 26 shows a perspective illustration of a further embodiment of the adjustment device according to the invention with a first base component in the form of an adjustment body housing, which comprises an adjustment body which is rotatably mounted on the adjustment body housing by means of a flexure hinge device, and which comprises two drive devices for adjusting the adjustment body, a second base component in which the first base component is rotatably accommodated by means of a further flexure hinge device and which can be rotated by means of two drive devices, wherein each drive device comprises an actor with a hollow-ring-shaped coil housing, in which a coil extends in its circumferential direction, and which comprises a compensation component and an arrangement of ferromagnetic segments that can be moved relative to the actor,

FIG. 27 shows a plan view of the embodiment of the adjustment device of FIG. 26,

FIG. 28 is a partially cutaway perspective view of the embodiment of the actuator of FIG. 26; and

FIG. 29 shows a further partially cut-away perspective illustration of the embodiment of the adjustment device of FIG. 26.

### DETAILED DESCRIPTION

The adjustment device 1 according to the invention comprises at least one electromagnetic drive device C, by means of which an actuation of movements of an adjustment body 10 relative to a base component B1 can be realized in at least one actuating movement direction. The base component can be, for example, an actuator housing or a frame device.

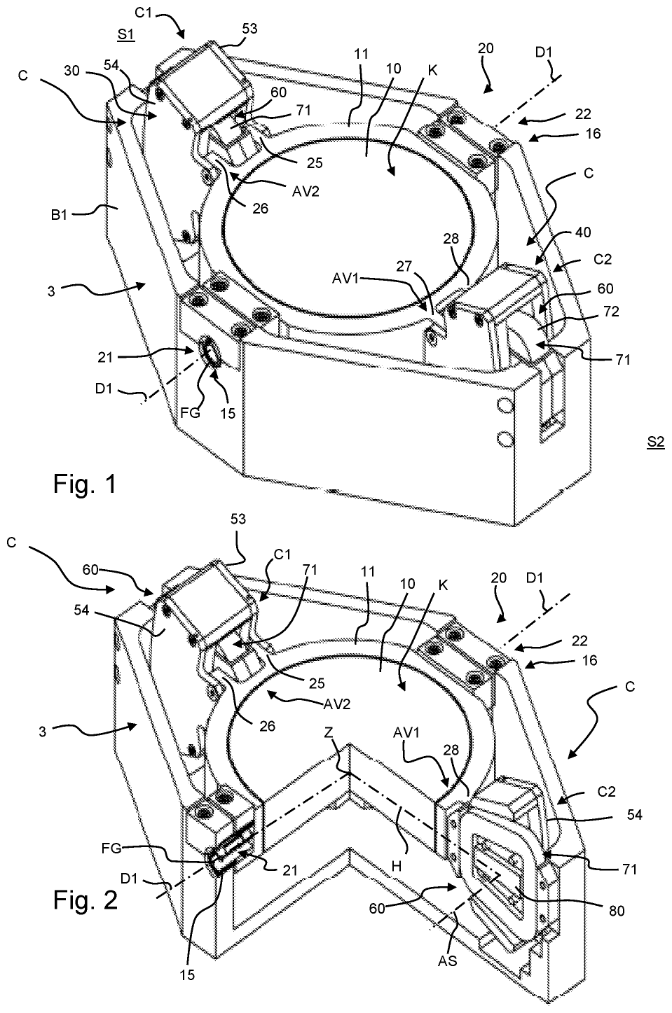

FIG. 1 shows an embodiment of the adjustment device 1 according to the invention with the base component in the form of an adjustment body housing 3 and the adjustment body 10. The adjustment body 10 is rotatably mounted on the adjustment body housing 3 by means of a flexure hinge device 20 in the form of a first flexure hinge 21 and a second flexure hinge 22 on the adjustment body housing 3 while providing an adjustment body rotation axis D1. The two flexure hinges 21, 22 are arranged diametrically opposite one another on an adjustment body frame 11 in the direction of the adjustment body rotation axis D1. In particular, the adjustment body rotation axis Di can run parallel to an axis of symmetry of the adjustment body 10.

For this purpose, in each embodiment of the adjustment device 1 according to the invention, it can be provided that it comprises only one flexure hinge. In this case, it can be provided that the adjustment body 10 is mounted in particular by means of only one of the two flexure hinges 21, 22 on the actuator housing 3, which defines the adjustment body rotation axis D1, is.

An application component K can be arranged on the adjustment body frame 11. The application component K may be received by or located on the adjustment body frame 11. The application component K can in particular be one or more of the following components or a combination of the following components: a sensor, a sensor retainer, a tool such as, for example, a mirror, a tool retainer.

Herein, a center Z is defined for the actuator 10. The center Z can in particular be the center of the length of the adjustment body rotation axis D1, which extends through the adjustment body 10 or the adjustment body frame 11.

The flexure hinge provided in each case according to the invention can be designed according to the prior art. The term “flexure hinge” is understood here to mean a specifically designed connection section between a first component and a second component, which, due to elastic and reversible, i.e., non-plastic deformation, allows a relative movement between the first and second components. The connection portion comprises a substantially reduced flexural rigidity relative to the region of the first and second component adjoining the connection portion. The reduced bending stiffness can be achieved by a local cross-sectional reduction of the connection portion or a special shaping of the connection portion or a greater elasticity of the material of the connection portion.

Each of the flexure hinges 21 or 22 can each comprise an axle component FG, which is fixed with a first end piece on in each case one pivot bearing retainer 15, 16 of the adjustment body frame 11. The pivot bearing retainers 15, 16 are arranged diametrically opposite one another in the direction of the adjustment body rotation axis D1. The axle components FG are each fixed to a corresponding housing retainer by a second end piece, which is located opposite the first end piece. In the case that the adjustment device 1 comprises only one of the flexure hinges 21, 22, it can be provided that the adjustment device 1 also comprises only one axle component FG.

A respectively provided flexure hinge can also be realized in a different way than with an axle component FG.

The axle component FG can form the connection section itself. The axle component FG can also comprise a cylindrical base body and the connection portion which is connected thereto and is arranged in the interior thereof and which, for example, extends radially inwards from the base body and on which the housing retainer is attached or fixed.

The adjustment body frame 11 is set in a rotary or tilting movement by a drive device C or a plurality of drive devices C. A drive device C is coupled, on the one hand, to a respective connection device AV of the adjustment body 10 or its adjustment body frame 11 and, on the other hand, to a receiving device of the base component or of the actuator housing 3. Each of the at least one adjustment body connection device AV is situated at a distance H from the adjustment body rotation axis D1. Each of the at least one drive device C is coupled to the base component B1 and to an adjustment body connection device AV, so that each of the at least one drive device C generates, during its actuation, an actuating movement which is situated at a distance H from the adjustment body rotation axis D1, so that an actuating movement along an actuation path causes a rotation or tilting of the adjustment body 10 about the adjustment body rotation axis D1 is effected. The embodiment of the adjustment device 1 according to the invention shown in FIGS. 1 and 2 comprises two drive devices C, each of which is assigned the reference numbers C1 and C2 individually. The drive device C1 is coupled to the adjustment body connection device AV1, while the drive device C2 is coupled to the adjustment body connection device AV2.

According to a further embodiment of the adjustment device according to the invention, it comprises only one drive device C, which is coupled to an adjustment body connection device AV of the adjustment body 10, which is situated at a distance H from the adjustment body rotation axis D1. According to a further embodiment of the adjustment device according to the invention, it comprises a plurality of drive devices C, each of which is coupled to an adjustment body connection device AV of the adjustment body 10, which are situated on the same side of the adjustment body rotation axis D1 at a distance H from the adjustment body rotation axis D1.

In order to couple a drive device C to the adjustment body frame 11, in the embodiment of the adjustment device 1 according to FIGS. 1 and 2, the adjustment device 1 comprises two adjustment body connection devices AV with two drive devices C1, C2. The adjustment body connection devices AV are arranged with respect to the adjustment body rotation axis D1 on regions of the adjustment body frame 11 which are situated opposite one another. Each of the adjustment body connection devices AV is realized in each case by two adjustment body connection portions. Accordingly, on a first side S1 of the adjustment body frame 11, two adjustment body connection portions 25, 26 and on a second side S2 of the adjustment body frame 11, which are opposite the first side S1 with respect to the adjustment body rotation axis D1, are located two adjustment body connection portions 27, 28 which are each connected to the adjustment body frame 11 and can be formed in particular in one piece with the adjustment body frame 11. The adjustment body connection sections 25, 26, 27, 28 project in the radial direction from the adjustment body frame 11. Each of the adjustment body connection sections 25, 26, 27, 28 can comprise a connection device, for example in the form of at least one bore, for connecting a drive device C.

As an alternative to this, one or more of the at least one adjustment body connection device AV can be replaced by only one adjustment body connection section can be realized. An adjustment body connection device AV can also be realized by a connection device introduced in the adjustment body frame 11. In addition, the adjustment body connection device AV can be a section of the adjustment body frame 11 itself.

In an alternative embodiment of the adjustment device 1 which is alternative to the embodiments shown, it comprises only one drive device C and in this case only one adjustment body connection device AV.

Embodiments of the drive devices C which can be integrated in each of the embodiments of the adjustment device 1 according to the invention are described below. In the figures, the same reference numerals are used for each of the various drive devices C shown. In various embodiments of the drive devices C, the same reference numerals are used for features or components which comprises the same function.

The at least one drive device C comprises an electrical coil 71. The coil 71 comprises at least one conductor winding and preferably a plurality of conductor windings which completely surround or surround a coil axis AS of the coil 71. The coil axis AS may be defined as a geometric center of the coil 71 or may be identical in position and direction to the central curvature-free field line.

In this case, it can in particular be provided that the coil axis AS runs along the flexure hinge rotation axis D1.

At least one drive device C can also comprise a coil device 70 with a coil housing 72 which partially or entirely surrounds the coil axis AS and in which the coil 71 is structurally integrated and in particular situated or held. In particular, the coil housing 72 can be designed as a hollow-ring-shaped coil housing in which the coil 71 is arranged, wherein the circumferential direction of the coil 71 extends along the circumferential direction of the coil housing 72. The coil housing 72 can also be designed as a coil housing in the form of a hollow ring in sections, so that the coil housing is not circumferentially closed. In the design of the coil housing 72 as a coil housing in the form of a hollow ring in sections, the geometric axis of the respective hollow ring section of the coil housing 72 runs in or along the coil axis AS of the coil 71.

Each drive device C comprises a compensation component 80. In each of the embodiment s of the adjustment device 1 according to the invention, the coil 71 or the coil housing 72 and the compensation component 80 can be fixed to one another or fixed to one another directly or indirectly, that is to say via a structural component, and together form an actuator 60, since an electric magnetic field is generated when the coil 71 is energized.

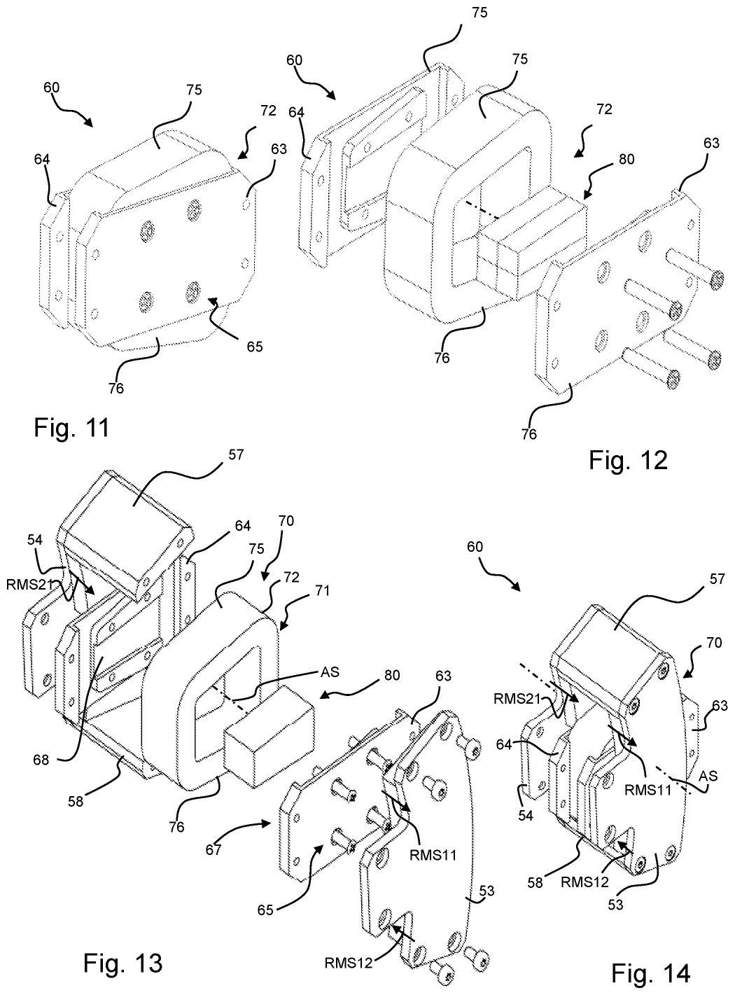

The compensation component 80, as is realized in the embodiment of the actuator 60 according to FIGS. 11 to 14, can be fixed to fastening parts 63, 64, which are attached the side of the coil, at the coil 71 or the coil housing 72. The fastening parts 63, 64 are located—as seen transversely to the coil axis AS—on sides of the coil 71 which are opposite one another with respect to the coil 71, wherein in each case one fastening part 63, 64 is situated on one side of the coil 71. In the embodiment of the actuator 60 according to FIGS. 11 to 14, the fastening parts 63, 64 are each realized in a plate-shaped manner. These can also be realized as a holder or as a clamp or bracket or rod. In the illustrated embodiment, the fastening parts 63, 64 are fastened to one another by at least one connecting element 65, wherein the connecting elements 65 press the fastening parts 63, 64 against the coil 71 or the coil housing 72 from the two sides. Between fastening parts 63, 64 the compensation component 80 is located, which is located laterally from mutually facing surfaces of the fastening parts 63, 64 and between them. In this case, the compensation component 80 can be held by the fastening parts 63, 64 and optionally pressed, wherein the fastening parts 63, 64 are also pressed against the coil 71 or the coil housing 72 from the two sides. The connection between the fastening parts 63, 64 and the compensation component 80 can also be realized by a respective at least partially form-fitting retainer of the compensation component 80 by means of at least one of the fastening parts 63, 64, wherein at least one of the fastening parts 63, 64 comprises a recess 67, 68 or a step or a web on which the compensation component 80 can be held and fixed.

Alternatively, the actuator 60 can also be realized in such a way that the compensation component 80 is held and fixed on the coil 71 or the coil housing 72 by a single shaped piece, which can be, for example, a U-shaped shaped piece which engages around the coil 71 or the coil housing 72 and receives the compensation component 80 between leg sections. Further alternatives include the potting of the coil 71 and the compensation component 80 to form a unit, for example with epoxy resin casting compound, or the encapsulation of coil 71 and compensation component 80 with a plastic material.

The fastening or fixing of the compensation component 80 to the at least one fastening part 63, 64 can also take place by a different connection device than by at least one connecting element 65, such as, for example, a clip connection. The at least one fastening part 63, 64 can also be glued or soldered to the coil 71 or the coil housing 72, this realization being able to take place with or without a connecting element 65.

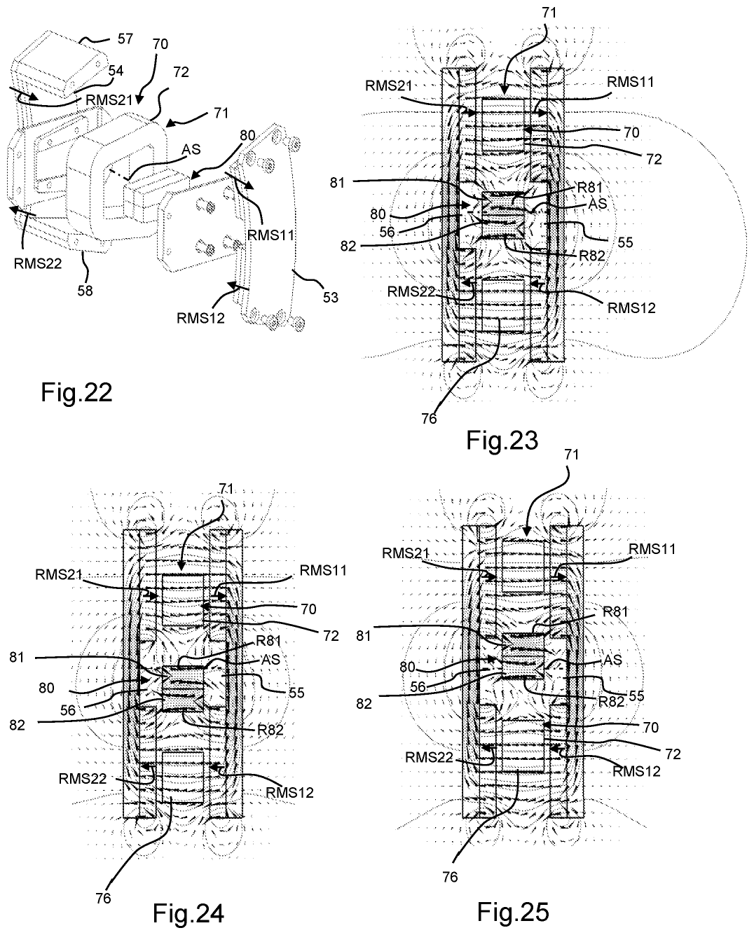

The compensation component 80 is preferably arranged outside a portion of the coil as seen in the coil axis AS. In particular, in each of the embodiments of the adjustment device, the arrangement of the compensation component can be provided according to one of the two alternatives: (K1) as seen in the coil axis AS, in the outer space surrounded by the inner circumference of the coil 71 or, in the case of an at least partially hollow-ring-shaped coil housing 72, in the outer space surrounded by the coil housing 72 (FIGS. 12 and 13 and 19 to 24); (K2) as seen in the coil axis AS, in the space located outside the outer circumference of the coil 71 or coil housing 72, or, in the case of an at least partially hollow-ring-shaped coil housing 72, in the outer space which surrounds the coil housing 72.

An embodiment of the actuator 60 according to the realization alternative (K2) is illustrated in FIGS. 17 and 18.

The compensation component 80 comprises a magnetizable or a magnetized material or can be produced from a soft or hard magnetic material. Preferably, the compensation component 80 is formed as a homogeneous material block and at the same time or as an alternative. In each embodiment of the adjustment device 1, the compensation component 80 can be configured in different shapes relative to one another. In particular, the compensation component 80 can be substantially cuboid or cylindrical, For this purpose, alternatively or additionally, the compensation component 80 is elongate with different cross-sectional shapes. In an elongated shape, the compensation component 80 can comprise a cross-sectional area with a circular or elliptical or square shape, with the shape of a rectangle or generally in the form of a polygon. In the case of an elongated shape, the compensation component 80 can comprise a center line running in the longitudinal direction thereof, which runs along or in the direction of the distance between the adjustment body rotation axis D1 and the coil axis AS when this distance runs through the center Z.

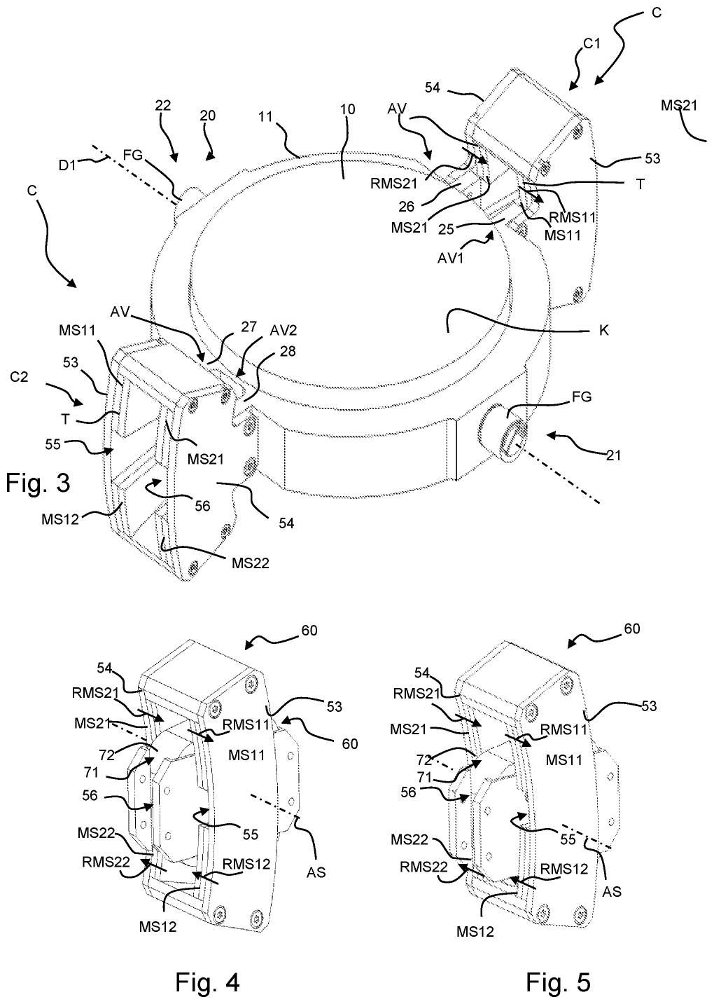

The adjustment device 1 according to the invention comprises at least one permanent magnet segment MS, which is mounted movably relative to the coil 71 or to the coil housing 72, from a hard magnetic material. In the figures, the permanent magnet segment MS is shown as an one-piece or one-piece component, wherein a separation line T is introduced, which however can be a fictitious separating line, The reference sign “T” is entered in FIG. 3. The separating line is shown in other figures without reference signs. This separation line T symbolically shows the separation between two magnetic poles, to which the magnetic field direction shown in each case by an arrow belongs. The position of the permanent magnet segment MS is within its range of movement, which is mechanically predefined on the basis of the coupling of the drive device C to the adjustment body 10 and to the base component B1 with respect to the coil 71 or the coil housing 72 is preferably provided in such a way that, (m1) that the magnetic field lines in the interior of the permanent magnet segment MS extend along or in the direction of the coil axis AS, (m2) that the permanent magnet segment MS is situated beside the coil 71 at a contactless distance which runs in the coil axis AS, wherein in a reference state of the drive device C a portion of the coil 71 or of the coil housing 72, when viewed in the coil axis AS, extends partially or completely, that is to say with its outer circumference, within the permanent magnet segment MS.

In each embodiment of the adjustment device 1 according to the invention, the permanent magnet segment MS can be generally in particular plate-shaped or cuboid-shaped, but can also comprise any other spatial shape. In the case that the permanent magnet segment MS is plate-shaped, the permanent magnet segment MS extends in a direction which runs in or along the relative movement between the coil and the permanent magnet segment upon actuation of a respective drive device. Furthermore, the at least one permanent magnet segment MS comprises a surface defining the longitudinal extension thereof, the orientation of which is directed along or in the direction of the coil axis AS.

The mounting of the drive device C on the adjustment device 1 for carrying out the adjustment movement can be provided according to one of the two alternatives (a), (b): (a) the actuator 60 is coupled to the base component B1 and the permanent magnet segment (MS) is coupled to the adjustment body connection device AV (moving magnet principle), (b) the actuator 60 is coupled to the adjustment body connection device AV and the permanent magnet segment MS is coupled to the base component B1 (moving coil principle).

In the embodiments of the adjustment device 1 shown in FIGS. 1 to 3, the alternative (a) is realized. In this case, the at least one permanent magnet segment MS can be arranged on a magnetic segment support. Such a magnetic segment support can in particular be situated on a surface of the at least one permanent magnet segment MS, which is oriented away from the coil 71. In the embodiments of the adjustment device 1 shown in FIGS. 1 to 3, two magnet segment carriers 53, 54 are arranged in each drive device C, which are each situated on sides which are situated opposite one another with respect to the coil 71. In general, provision can be made for a permanent magnet segment MS or more than one permanent magnet segment MS, that is to say two or more than two permanent magnet segments MS, to be arranged on in each case one magnetic segment support.

Optionally, the magnetic segment supports 53, 54 may be attached to each other. This fastening can be realized by means of at least one connecting piece. An example of this implementation is illustrated in the embodiment of the actuator 60 shown in FIGS. 11 to 14. In this embodiment of the actor 60, the actuator 60 comprises two connecting pieces 57, 58, which each connect two end sections of the magnet segment carriers 53, 54 to one another. The end portions of each of the magnetic segment supports 53, 54 are located at ends of the respective magnetic segment support 53, 54 opposite to one another in directions of the relative movements between the coil 71 and the at least one permanent magnet segment MS. The at least one connecting piece can be fastened to the respective end section by means of at least one connecting element. This fastening can also be provided by a different way, for example by soldering or adhesive bonding or a form-fitting fastening.

The magnetic segment support 53, 54 is preferably formed from a soft magnetic steel which readily conducts the field of the preferably glued permanent magnet segments MS on the adhesive side. Alternatively, the magnetic segment support may be formed of a non-magnetic material such as aluminum, plastic, etc. However, when using a non-magnetic material, the efficiency of the corresponding actor of the adjustment device decreases, since the magnetic field of the permanent magnet segment or permanent magnet segments are not guided, as a result of which negatively influencing stray fields form.

In the embodiments described above, it may in particular be provided that the coil axis AS runs along the flexure hinge rotation axis D1. As an alternative to this, it can be provided that the relative movement direction of the relative movement between the coil 70 and at least one permanent magnet segment of a drive device C runs transversely to a plane which is spanned by the flexure hinge rotation axis of the adjustment body and of the adjustment body connection device on which the respective actuator is coupled. In this case, it can also be provided that the coil axis runs transversely to the flexure hinge rotation axis D1.

The mode of operation of the adjustment device 1 according to the invention with the actor 60 is as follows:

The actor 60 is actuated by electrically controlling the coil 71 so that this current flows. As a result, the coil 71 generates in its interior a magnetic field whose magnetic field lines in the interior of the coil 71 or of the coil housing 72 extend in or along the coil axis AS. This coil magnetic field produces in cooperation or in interaction with the magnetic field generated by a permanent magnet segment MS, a force between the one permanent magnet segment MS and the coil 71, which provides a deflection force for the desired adjustment movement or tilting of the adjustment body, results in an attractive force between the one permanent magnet segment MS and the compensation component 80 due to the corresponding displacement between the permanent magnet segment MS and the coil 71. The actuating movement can cause the permanent magnet segment MS and the coil 71 to move relative to one another in a direction in which, as seen in the coil axis AS, the relevant permanent magnet segment MS comes to the height or into the region of the compensation component 80.

This comprises the effect that the resulting attractive force counteracts a return movement inclination of the adjustment body, caused by the deflected or elastically deformed flexure hinges.

The force (attractive force) produced during current flow in the coil between the compensation component 80 and the permanent magnet segment MS acts in a direction which is opposite to the direction of the movement of the permanent magnet segment MS generated on the basis of the deflection force relative to the coil 71. In this way, this attractive force counteracts the restoring force which the at least one flexure hinge exerts on the adjustment body 10 with the occurrence of the actuating movement of the same. In this case, the adjustment device 1 is designed in such a way that the drive device or its components, the compensation component and the permanent magnet segment MS at least partially, i.e., partially or completely, compensates the restoring force which the at least one flexure hinge exerts on the adjustment body 10.

In this context, the said two positions of the compensation component relative to the permanent magnet segment are defined in particular by: a first relative position, which is an initial relative position, which is realized in particular in the case of the reference state of the actor 60, and in which no or only very small or only very small or negligible attraction forces exist between the compensation component and the permanent magnet segment, and a second relative position, which is an adjustment relative position, in which the compensation component 80 is situated in a region in which a greater interaction between the compensation component and the permanent magnet segment exists so that there is a stronger attractive force between the permanent magnet segment and the compensation component than in the first relative position.

The reference state of the actor 60 or of the adjustment device 1 is understood here in particular to mean the state which the actor 60 assumes when the coil 71 is not electrically actuated and from which the permanent magnet segment MS and the coil 71 move relative to one another when the coil 71 is electrically activated or activated.

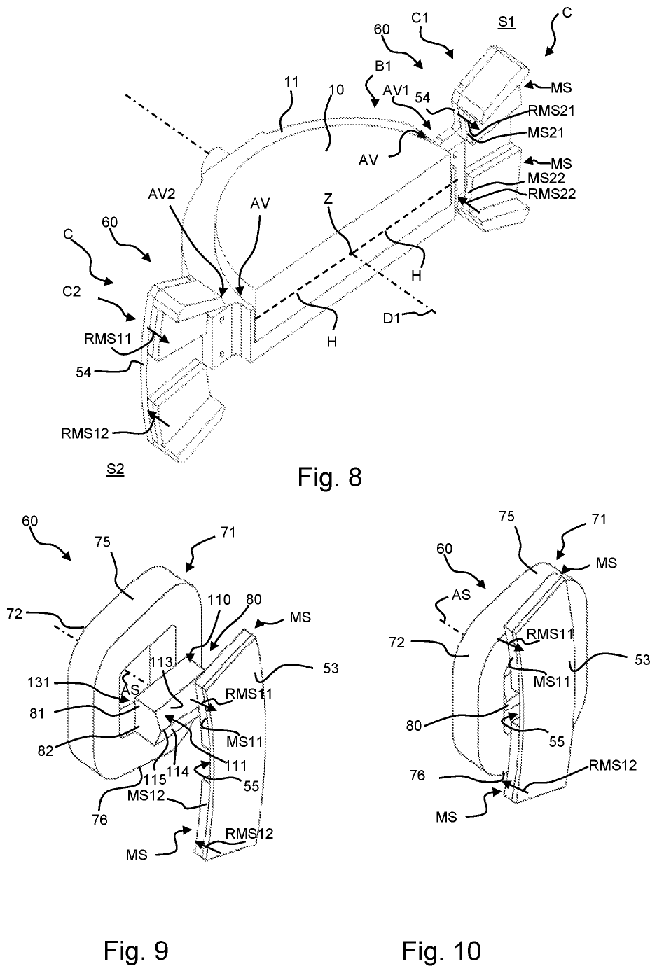

In each of the embodiments of the adjustment device 1 according to the invention, the at least one drive device C can each comprise at least one permanent magnet segment MS and in particular one or two or four permanent magnet segments MS, but also a different number of permanent magnet segments MS. For example, a drive device C of the adjustment device 1 according to the invention can comprise two permanent magnet segments MS, which, for example, are fastened on a magnetic segment support 53, wherein the permanent magnet segments MS are situated on the same side of the actuator 60 as seen from the center Z or the coil axis AS. The magnet segment carrier 53 can be plate-shaped. The size of the magnetic segment support 53 is preferably provided in such a way that the two permanent magnet segments MS are completely situated on an outer surface of the magnetic segment support 53. In this case, the two permanent magnet segments MS can be situated on that outer surface of the magnetic segment support 53 which is situated facing the coil 71. Thus, the two permanent magnet segments MS fastened to the magnet segment carrier 53, when viewed in a viewing direction which runs along the direction of the distance between the adjustment body rotation axis D1 and the coil axis AS, are arranged on one side of the coil 71 or of the coil housing 72. Such a configuration of the actuator 60 is illustrated in FIG. 8 and in FIGS. 9 and 10. The realization of the actuator 60 in FIG. 8 differs, when viewed in a viewing direction transverse to the plane which is spanned by the adjustment body rotation axis D1 and the lever, with regard to the side of the actor 60 on which the two permanent magnet segments MS according to FIGS. 9 and 10 are arranged. In the illustration of FIG. 8, the actor 60 located on a first side S1 accordingly comprises a magnetic segment support 53 with the permanent magnet segments MS11, MS12 and the actor 60 located on a second side S2 comprises a magnetic segment support 54 with the permanent magnet segments MS21, MS22. In FIGS. 9 and 10, in each case the magnet segment support 54 with the permanent magnet segments MS21, MS22 is shown.

The reference signs MS11, MS12 are assigned to the two permanent magnet segments arranged on the magnetic segment support 53. The permanent magnet segments MS11, MS12 arranged on a magnetic segment support 53 are arranged beside one another as viewed from the center Z or the coil axis AS and as seen in the direction of the coil axis AS and are arranged one behind the other in the directions of the relative movements between the coil 71 and the at least one permanent magnet segment MS. Also, the individual permanent magnet segments MS11, MS12 are arranged one behind the other in the direction of the relative movement between the coil 71 or permanent magnet segments MS11, MS12. Preferably, the two permanent magnet segments MS11, MS12 arranged on a magnetic segment support 53 are separated by a continuous gap 55, which extends in each case along the direction of the distance between the adjustment body rotation axis D1 and the coil axis AS, when this distance passes through the center Z.

In this embodiment, the permanent magnet segments MS11, MS12 are polarized from the adjustment body rotation axis D1 in different directions directed in or along the coil axis AS. This is illustrated by way of example in FIG. 9: In the case of the permanent magnet segment MS11, the magnetic field lines or the north-south direction are directed away from the coil, so that the north pole is situated on the side of the permanent magnet segment MS11 facing the coil 71. This magnetic field line direction is indicated in FIG. 9 by an arrow and the reference sign RMS11. In contrast, in the case of the permanent magnet segment MS12, the magnetic field lines or the north-south direction are directed towards the coil, so that the south pole is situated on the side of the permanent magnet segment MS12 facing the coil 71. This magnetic field line direction is indicated in FIG. 9 by an arrow and the reference sign RMS12.

The compensation component 80 may be formed or made of a soft magnetic material. Alternatively, the compensation component 80 can be formed from a hard magnetic material and comprise two polarization regions 81, 82. In this case, in the case of a reference state or the zero position of the drive device, the center line of the compensation component 80, which runs along the direction of the distance between the adjustment body rotation axis D1 and the coil axis AS, is situated between the first permanent magnet segment MS11 and the second permanent magnet segment MS12. In embodiments in which the permanent magnet segments MS11, MS12 are separated by a continuous gap 55, in the reference state or in the zero position, this center line is situated at the height of the gap 55 in the directions of the relative movements between the coil 71 and the permanent magnet segments MS11, MS12. In this zero position, a first polarization region 81 is polarized in such a way that its magnetic field line direction R81 runs along the magnetic field line direction RMS11 of the first permanent magnet segment MS11 and that its magnetic field line direction R82 runs along the magnetic field line direction RMS12 of the second permanent magnet segment MS12.

In particular in the embodiments of the adjustment device 1 with a drive device C, in which permanent magnet segments MS11, MS12, as seen from the adjustment body rotation axis D1, are located on only one side of the coil 71, the shaping of the compensation component 80 can be provided according to the compensation component shown in FIG. 9, which is provided with the reference sign 110. The compensation component 110 comprises a surface or side surface 111 which faces the arrangement of the permanent magnet segments MS11, MS12. Furthermore, the compensation component 80 comprises a further surface or side surface 131, which is situated opposite the side surface 111. The surface 111 can be formed from two partial surfaces 113, 114, which extend at an angle to one another as seen from the adjustment body rotation axis D1. As a result, the partial surfaces 113, 114 meet one another in a line 115 which runs along the gap 55. The partial surfaces 113, 114 or cut contour lines thereof, which result from the adjustment body rotation axis D1, extend along the coil axis AS, viewed along the coil axis AS, at an angle between 10 degrees and 95 degrees. The line 115 may also be an edge line. Alternatively, the meeting of the end sections in the line 115 can take place in a section whose contour lines of the same, which result from the adjustment body rotation axis D1, are spherically curved in the direction to the arrangement of the permanent magnet segments MS11, MS12.

In these embodiments, the side surface 111, which faces the arrangement of the permanent magnet segments MS11, MS12, can comprise two, in particular straight-surfaced or spherical partial surface portions 113, 114, the orientations of which extend at an angle between 10 degrees and 40 degrees with respect to the coil axis AS, wherein the angles in the zero position or in the reference state, viewed from the center Z, open in one direction in which the respectively closer permanent magnet segment MS11, MS12 of the arrangement of permanent magnet segments is situated.

Such a compensation component 110 can in particular be provided if a continuous gap 55 is provided between the permanent magnet segments MS11, MS12 or not.

In general, in the case of a drive device C, which comprises at least one arrangement of two permanent magnet segments MS11, MS12, which are situated on at least one side of the coil 71 as seen from the center Z, a compensation component SO can comprise which comprises: a side surface 111 which faces the arrangement of the permanent magnet segments MS11, MS12, wherein the side surface 111 comprises two straight surfaces, i.e. uncurved partial surface portions 113, 114, the orientations of which extend at an angle between 10 degrees and 40 degrees with respect to the coil axis AS. In this respect, the angles open in the zero position or in the reference state, when viewed from the centre, in a direction in which the respectively closer permanent magnet segment MS11, MS12 of the arrangement of permanent magnet segments MS11, MS12 is situated.

FIG. 7 schematically shows the zero position or the reference state of the illustrated actuator 60. As shown in FIG. 7, the actuator 60 provided according to the invention can be designed and arranged in such a way that, that in the reference state—as seen in the coil axis AS—a first permanent magnet segment MS11 of the pair of permanent magnet segments overlaps a first coil section 75 of the coil 71 in a section and a second permanent magnet segment MS12 of the pair of permanent magnet segments overlaps a second coil section 76 of the coil 71 in a section. In this case, the first coil section 75 of the coil 71 and the second coil section 76 of the coil 71 are arranged opposite one another with respect to the coil axis AS, for example, viewed from the adjustment body rotation axis D1, i.e. arranged one behind the other in the directions of the relative movements between the coil 71 and the at least one permanent magnet segment MS.

In an embodiment of the adjustment device 1 according to the invention with a total of only one permanent magnet segment MS, which is arranged on one side of the coil 71, as seen from the adjustment body rotation axis D1, the latter can be designed and arranged in such a way that, in the reference state—as viewed in the coil axis AS—the permanent magnet segment MS overlaps the coil section 75 or 76 of the coil 71 at least in a section. In an analogous manner, in one embodiment of the adjustment device 1 according to the invention with two permanent magnet segments MS, which—when viewed in a viewing direction transverse to the plane, which is spanned by the adjustment body rotation axis D1 and by the lever which is defined by the distance, or when viewed in the coil axis AS—are arranged in each case on one side of the coil 71, the respective permanent magnet segment MS in the reference state of the actuator 60, as viewed in the coil axis AS, may at least in a section overlap the coil section 75 or the coil section 76 of the coil 71.

In each embodiment of the adjustment device 1 according to the invention, the movement region thereof can be defined in such a way that, viewed in the direction of the coil axis AS, in the movement region at least an overlap or covering of a permanent magnet segment MS by one of the coil sections 75, 76 is provided, which is spaced apart from the coil axis AS in the direction of a relative movement between the coil 71 and the at least one permanent magnet segment MS.

Furthermore, in each of the embodiments of the adjustment device 1 according to the invention, it can be provided that at least one drive device C comprises two pairs of permanent magnet segments MS11, MS12, MS21, MS22, of which in each case a pair of permanent magnet segments MS11, MS12, MS21, MS22 are fastened on a magnetic segment support 53, 54. Namely a first pair of permanent magnet segments MS11, MS12 is disposed on a first magnetic segment support 53 and a second pair of permanent magnet segments MS21, MS22 is disposed on a second magnetic segment support 54. Here, each pair of permanent magnet segments MS11, MS12 or MS21, MS22 is disposed, when viewed from the center Z or from the coil axis AS, on mutually different sides of the coil 71 or of the actuator 60. In this regard, in each case two permanent magnet segments MS11, MS21 and the two permanent magnet segments MS12, MS22 are, when viewed from the adjustment body rotation axis D1, arranged beside one another in the direction of the coil axis AS.

The two permanent magnet segments MS11, MS12 or MS21, MS22 which are arranged on a magnetic segment support 53, 54 are preferably separated by a continuous gap 55 or 56, which runs in each case along the direction of the distance between the adjustment body rotation axis D1 and the coil axis AS when this distance runs through the center Z. The gaps 55, 56 are situated opposite one another or at the same height in the directions of the relative movements between the coil 71 and the permanent magnet segments.

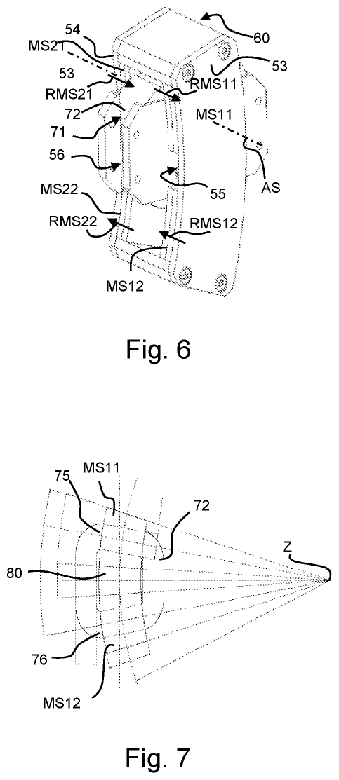

Embodiments of the drive device with these features are shown in FIGS. 3 to 6 and in FIG. 13, The permanent magnet segments MS11, MS12 are arranged on a first magnetic segment support 53 and the permanent magnet segments MS21, MS22 are arranged on a second magnetic segment support 54. In the embodiments of the drive device shown in FIGS. 3 to 6 or FIG. 13, according to a variant of the drive device according to the invention, the pair of permanent magnet segments MS11, MS12 or the pair of permanent magnet segments MS21, MS22 may not be present.

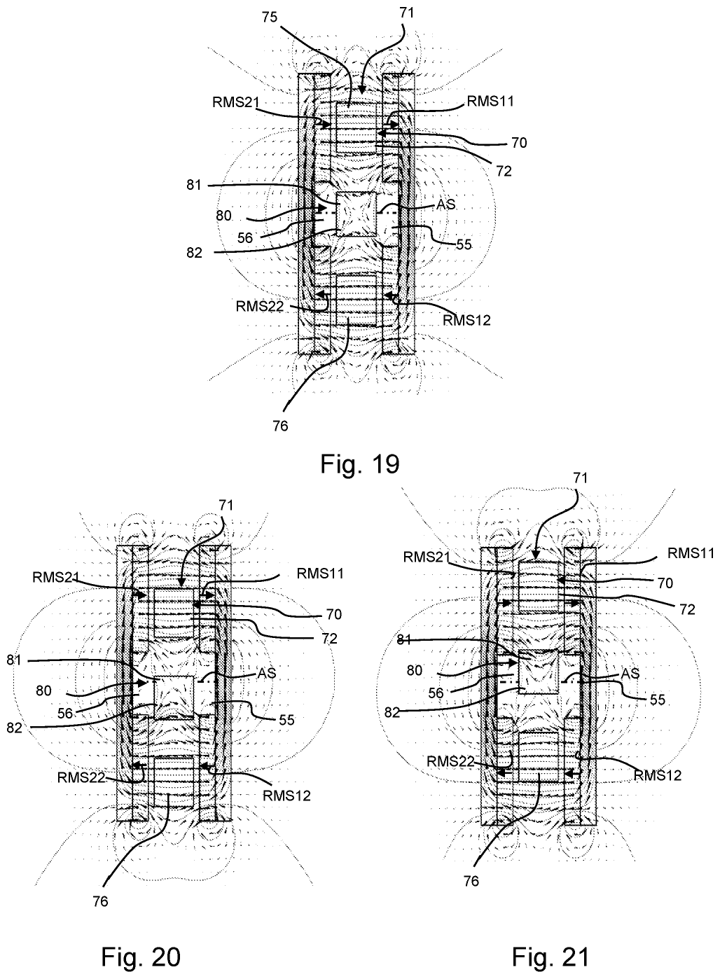

In embodiments of the drive device with two pairs of permanent magnet segments MS11, MS12 or MS21, MS22, the permanent magnet segments MS11, MS21 and MS21, MS22, which, when viewed from the adjustment body rotation axis D1, are arranged beside one another in the direction of the coil axis AS, are preferably polarized in the same direction and the permanent magnet segments MS11, MS12 and MS21 which are arranged beside one another vertically to the coil axis AS, MS22 are preferably polarized in different directions. This is illustrated by way of example in FIGS. 4 to 6 and in FIGS. 19 to 21 and FIGS. 23 to 25: In the case of the permanent magnet segments MS11, MS21, the magnetic field lines or the north-south direction are directed away from the coil, so that the north poles are situated on the side of the permanent magnet segments MS11, MS21 facing the coil 71. In contrast, in the case of the permanent magnet segments MS12, MS22, the magnetic field lines or the north-south direction are directed towards the coil, so that the south poles are situated on the side of the permanent magnet segments MS12, MS22 facing the coil 71.

FIG. 7 and FIGS. 19 and 23 schematically show the zero position or the reference state of the illustrated actuator 60. It can be seen from these illustrations that in this embodiment of the actuator 60 provided according to the invention, the compensation component is designed and arranged in such a way that, in the reference state or the zero position, first permanent magnet segments MS11, MS21 of different pairs of permanent magnet segments which in each case are disposed, when viewed in the direction of the coil axis AS, one behind the other overlap in a section a first coil section 75 and second permanent magnet segments MS12, MS22 of different pairs of permanent magnet segments which in each case are disposed, when viewed in the direction of the coil axis AS, one behind the other in each case overlap in sections a second coil section 76. In this case, the first coil section 75 and the second coil section 76 are arranged opposite one another with respect to the coil axis AS, i.e., in the directions of the relative movements between the coil 71 and the at least one permanent magnet segment MS are arranged one behind the other. In particular, it is provided according to the invention that the first coil section 75 and the second coil section 76 run at least in a section along the direction of the distance between the adjustment body rotation axis D1 and the coil axis AS, in particular if this distance runs through the center Z.

In the embodiments of the adjustment device 1 with at least one drive device C which comprises in each case a pair of permanent magnet segments MS11, MS12 or MS21, MS22 on both sides of the coil 71, the compensation component 80 can be formed or made of a soft magnetic material.

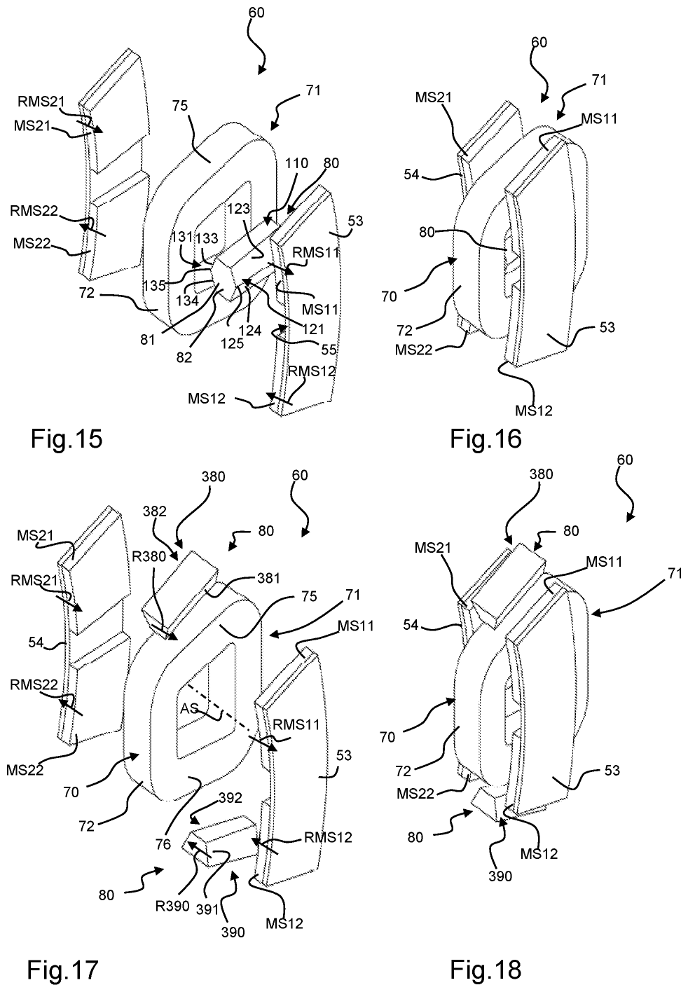

In these embodiments of the actor 60, the compensation component 80 can alternatively be formed or consist of a hard magnetic material, and can be polarized in different directions analogously to the drive device C, in which permanent magnet segments MS11, MS12 are located only on one side of the coil 71 (FIG. 15). In this case, the compensation component is formed from two polarization regions 81, 82, wherein, in the case of a reference state or the zero position of the drive device, the center line of the compensation component 80, which runs along the direction of the distance between the adjustment body rotation axis D1 and the coil axis AS, is situated between the first permanent magnet segment MS11 and the second permanent magnet segment MS12. In embodiments in which the permanent magnet segments MS11, MS12 are separated by a continuous gap 55 and the permanent magnet segments MS21, MS22 are separated by, a continuous gap 56, in the reference state or in the zero position this center line is located, in the directions of the relative movements between the coil 71 and the permanent magnet segments MS11, MS12, at the height of the gaps 55, 56. In particular in this zero position, a first polarization region 81 is polarized in such a way that its magnetic field line direction R81 runs along the magnetic field line direction RMS11 of the first permanent magnet segment MS11 and along the magnetic field line direction RMS21 of the first permanent magnet segment MS11. Furthermore, a second polarization region 82 is polarized in such a way that its magnetic field line direction R82 runs along the magnetic field line direction RMS12 of the second permanent magnet segment MS12 and along the magnetic field line direction RMS22 of the second permanent magnet segment MS22.

In the embodiments of the adjustment device 1 with a drive device C, in which in each case a pair of permanent magnet segments MS11, MS12 or MS21, MS22 is situated on each side of the coil 71, and the compensation component 80 comprises or consists of a soft magnetic or hard magnetic material, the shaping of the compensation component 80 can be provided according to the compensation component shown in FIG. 15, which is provided with the reference sign 110. The compensation component 110 comprises a first surface 121, which faces the arrangement of the permanent magnet segments MS11, MS12, and a second surface 131, which faces the arrangement of the permanent magnet segments MS21, MS22. The surfaces 121, 131 are each formed from two partial surfaces 123, 124 or 133, 134, which each extend at an angle to one another as seen from the adjustment body rotation axis D1. As a result, the partial surfaces 123, 124 meet one another in a line 125 which runs along the gap 55, and the partial surfaces 133, 134 meat each another in a line 135 which runs along the gap 56. The partial surfaces 123, 124 or cut contour lines thereof as well as the partial surfaces 133, 134 or cut contour lines thereof, which result from the adjustment body rotation axis D1, extend along the coil axis AS in a central portion, or their end portions, which meet each other in the line 125 or 135, at an angle of between 10 degrees and 95 degrees. The lines 125 or 135 can also each be an edge line. Alternatively, the meeting of the end sections in the line 125 or 135 can take place in a section, the contour lines of which, which result from the adjustment body rotation axis D1, are spherically curved in the direction to arrangement of the permanent magnet segments MS11, MS12 or to arrangement of the permanent magnet segments MS21, MS22. Such a compensation component 110 can be provided if a continuous gap 55 is present between the permanent magnet segments MS11, MS12 and the permanent magnet segments MS21, MS22 or not.

In general, in these embodiments, the side surface 121, which faces the arrangement of the permanent magnet segments MS11, MS12, can comprise two side faces 123, 124, the orientations of which are each aligned with an angle between 10 degrees and 40 degrees with respect to the coil axis AS wherein the angles in the zero position or in the reference state, viewed from the center Z, open in a direction in which the respectively closer permanent magnet segment MS11, MS12 of the arrangement of permanent magnet segments MS11, MS12 is situated. In general, in these embodiments, the side surface 131, which faces the arrangement of the permanent magnet segments MS21, MS22, can comprise two side surfaces 133, 134, the orientations of which are each aligned with an angle between 10 degrees and 40 degrees with respect to the coil axis AS, wherein the angles in the zero position or in the reference state, viewed from the center Z, open in a direction in which the respectively closer permanent magnet segment MS21, MS22 of the arrangement of permanent magnet segments MS21, MS22 is situated.

According to the realization alternative (K2) defined herein, the compensation component 80 can be situated in the space which is located in the space which is located outside the outer circumference of the coil 71 or coil housing 72, as seen in the coil axis AS.

FIGS. 17 and 18 show an embodiment of the actor 60 in which the compensation component 80 is formed from a first compensation element 380 and a second compensation element 390. Both compensation elements 380, 390 are located in the space located outside the outer circumference of the coil 71 or coil housing 72. A first compensation element 380 is located on the first coil section 75 of the coil 71 and a second compensation element 390 is located on the second coil section 76 of the coil 71. Both compensation elements 380, 390 and the coil 71 are situated one above the other—viewed in the directions of the relative movements between the coil 71 and the at least one permanent magnet segment MS.

The first compensation element 380 comprises a first side surface 381, which faces the arrangement of the permanent magnet segments MS11, MS12, and a second side surface 382, which is situated opposite the first side surface 381 and which is situated facing the arrangement of the permanent magnet segments MS21, MS22. The side surface 381, which faces the arrangement of the permanent magnet segments MS11, MS12, comprises an orientation which runs at an angle between 10 degrees and 40 degrees with respect to the coil axis AS. As an alternative or in addition, generally the side surface 381 can comprise an in particular even-flat or spherical partial surface section, whose orientation runs at an angle between 10 degrees and 40 degrees with respect to the coil axis AS, wherein the angle, in the zero position or in the reference state, when viewed from the center Z, opens in a direction in which the closer permanent magnet segment MS11 of the arrangement of permanent magnet segments MS11, MS12 is situated. Furthermore, that side surface 382, which faces the arrangement of the permanent magnet segments MS21, MS22, comprises an orientation which runs at an angle between 10 degrees and 40 degrees with respect to the coil axis AS. Alternatively or additionally, the side surface 382 can generally comprise an in particular straight-surfaced or spherical partial surface portion, the orientation of which extends at an angle between 10 degrees and 40 degrees with respect to the coil axis AS, wherein the angle in the zero position or in the reference state, viewed from the center Z, opens in a direction in which the closer permanent magnet segment MS21 of the arrangement of permanent magnet segments MS21, MS22 is situated.

The second compensation element 390 comprises a first side surface 391 which faces the arrangement of the permanent magnet segments MS11, MS12, and a second side surface 392 which is situated opposite the first side surface 391 and the arrangement of the permanent magnet segments MS21, MS22. The side surface 391, which faces the arrangement of the permanent magnet segments MS11, MS12, has an orientation which runs at an angle between 10 degrees and 40 degrees with respect to the coil axis AS. Alternatively or additionally, the side surface 391 can generally comprise an in particular straight or spherical partial surface section, the orientation of which runs at an angle between 10 degrees and 40 degrees with respect to the coil axis AS, wherein the angle, in the zero position or in the reference state, seen from the center Z, opens in a direction in which the closer permanent magnet segment MS12 of the arrangement of permanent magnet segments MS11, MS12 is located. Furthermore, that side surface 392, which faces the arrangement of the permanent magnet segments MS21, MS22, comprises an orientation which runs at an angle between 10 degrees and 40 degrees with respect to the coil axis AS. Alternatively or additionally, the side surface 392 can generally comprise an in particular straight or spherical partial surface section, the orientation of which runs at an angle between 10 degrees and 40 degrees with respect to the coil axis AS, wherein the angle in the zero position or in the reference state, viewed from the center Z, opens in a direction in which the closer permanent magnet segment MS22 of the arrangement of permanent magnet segments MS21, MS22 is situated.

The compensation elements 380, 390 may each be formed or made of a soft magnetic material or a hard magnetic material. In FIG. 17, the compensation element magnetic field directions R380 and R390 are entered. The compensation element magnetic field direction of the compensation element located on the first or second coil section 75, 76 is provided in such a way that it runs in the direction or along the magnetic field line direction of the permanent magnet segment which is situated on the same coil section as the respective compensation element 380, 390. Accordingly, the compensation element magnetic field direction 8380 extends in or along the magnetic field line direction RMS11 of the permanent magnet segment MS11 and the magnetic field line direction RMS21 of the permanent magnet segment MS21 and the compensation element magnetic field direction R390 extends in or along the magnetic field line direction RMS12 of the permanent magnet segment MS12 and the magnetic field line direction RMS22 of the permanent magnet segment MS22.

In variants of this embodiment of the actor 60, it can be realized in such a way that. the same comprises only one of the two compensation elements 380, 390, that is to say either the compensation element 380 which is located on the first coil section 75 or the compensation element 390 which is located on the first coil section 76. This is in particular the case when the actuator 60 is realized in such a way that only one permanent magnet segment MS is arranged on one side or on both sides of the coil 71. In these variants, the respective compensation element 380, 390 is situated on that coil section 75, 76, which at least partially overlaps or covers the respective coil section 75, 76 when seen in the coil axis AS, at least in the reference state. The compensation element magnetic field direction of the compensation element located on the first or second coil section 75, 76 is provided in such a way that it runs in the direction or along the magnetic field line direction of the permanent magnet segment which is situated on the same coil section as the respective compensation element 380, 390. An example of a drive device C, in which a pair of permanent magnet segments MS11, MS12 or MS21, MS22 is located on each side of the coil 71, is described below with reference to FIGS. 19 to 21 and FIGS. 23 to 25.

The embodiment of the drive device C shown in FIGS. 19 to 21 comprises a compensation component which is formed from a soft-magnetic material. Starting from the reference state or zero position shown in FIG. 19, the coil 71 can be electrically energized, for example, in such a way that current flows in the first coil section 75 in a direction which is directed towards the adjustment body rotation axis D1 and current flows in the second coil section 76 in a direction which is directed away from the adjustment body rotation axis D1. The direction of the electrical current in the coil sections 75, 76 and the magnetic field line directions RMS11, RMS12, RMS21 RMS22 bring about a deflection or movement of the actuator 60 with a corresponding relative displacement between the compensation component 80 and the permanent magnet segments MS11, MS12, MS21, MS22. The effect of a movement of the actor relative to the permanent magnet segments MS11, MS12, MS21, MS22 is the adjustment state of the drive device C shown in FIG. 20 or FIG. 21.

The deflection or movement of the actor 60 in an adjustment state, caused by the energization of the coil 71 in cooperation with the permanent magnet segments, leads to magnetic field line distributions which can likewise be taken from FIGS. 19 to 21 and which differ from the magnetic field line distributions which exist according to FIG. 19 in the reference state. Due to the resulting asymmetrical magnetic field line distribution in an adjustment state of the drive device, the desired configuration or amplification of attraction forces between the compensation component 80 and the corresponding permanent magnet segments MS11, MS12, MS21, MS22 occur, which support the deflection or movement of the actuator caused by the energization of the coil 71 and which counteract or partially or completely compensate the restoring force produced on the basis of this deformation of the flexure hinges 21 or 22 analogue to the deflection.

The force acting between the compensation component 80 and the corresponding permanent magnet segments MS11, MS12, MS21, MS22 is dependent on the deflection of the adjustment body 10 and is greater than the absolute value=0 as soon as the actor 60 is deflected out of the reference state. The deflection of the adjustment body 10 is determined by the current flowing through the coil 71: The current-dependent actor force arises from the interaction between the magnetic field of the permanent magnet segments and the current density within the coil 71 (Lorentz force). The attractive force which is produced between the compensation component 80 and the permanent magnet segments is largely independent of the electric current conducted through the coil. The force effect between the compensation component 80 and the permanent magnet segments results from the tendency of the energy minimization between the outer magnetic field, which is caused by the permanent magnet segments, and optionally the own magnetic field of the compensation component 80 or its magnetic permeability, depending on the embodiment of the actor 60.

If, on the other hand, for example, the coil 71 is electrically energized in such a way that current flows in the first coil section 75 in a direction which is directed away from the adjustment body rotation axis D1 and current in the second coil section 76 flows in a direction which is directed towards the adjustment body rotation axis D1, this together with the magnetic field line directions RMS11, RMS12, RMS21 and RMS22 causes a deflection of the actor 60 in a direction opposite to the deflection according to FIG. 20, as shown in FIG. 21.

The embodiment of the drive device C shown in FIGS. 23 to 25 comprises a compensation component 80 made of a hard magnetic material so that magnetic field line directions R81 and R82 occur, as described with reference to FIG. 15 herein. In this case, the adjustment state shown in FIG. 24 corresponds to the adjustment state shown in FIG. 20 with the direction of the electric current in the coil 71 described in FIG. 20 and mode of operation. Furthermore, the adjustment state shown in FIG. 25 corresponds to the setting state shown in FIG. 21 with the direction of the electric current in the coil 71 described in FIG. 21 and mode of operation. By using a hard magnetic material for the compensation component 80, the above-described effect of the mutual attraction between the compensation component 80 and the permanent magnet segments MS11, MS12, MS21, MS22 can be amplified.

The modes of operation described with reference to FIGS. 19 to 21 and FIGS. 23 to 25 also apply in the case that the drive device C comprises a pair of permanent magnet segments MS11, MS12 only on a first side of the actuator 60 or in the case that the drive device C comprises a pair of permanent magnet segments MS21, MS22 only on a second side of the actor 60.

The modes of operation described with reference to FIGS. 19 to 21 and FIGS. 23 to 25 also apply in the case that the drive device C comprises only one permanent magnet segment, one coil 71 and one compensation component 80. In this case, it can be provided in particular that the individual permanent magnet segment of the drive device C in a reference state or the zero position, as seen in the coil axis AS, is situated at least in a section in the first coil section 75 or the second coil section 76, wherein the first coil section 75 and the second coil section 76 run at least in a section along the direction of the distance between the adjustment body rotation axis D1 and the coil axis AS, in particular if this distance runs through the center Z.

The mode of operation described with reference to FIGS. 19 to 21 and FIGS. 22 to 25 takes place in an opposite sense thereto if the actor 60 is realized according to the embodiment illustrated in FIGS. 17 and 18 or as a variant thereof. In a further embodiment of the adjustment device 1 according to the invention, it can be provided that the arrangement comprising the base component B1, the adjustment body 10, the flexure hinge device 20 and at least one drive device C, which is realized according to one of the embodiments described herein and by means of which the adjustment body 10 can be adjusted relative to the base component B1, is pivotally supported in a second base component B2 by means of a joint device and in particular a flexure hinge device 420, wherein the rotary bearing provides a base component rotation axis D2, which runs transversely to the adjustment body rotation axis D1 and in particular vertically to the adjustment body rotation axis D1. As a result, a cardanic support of the adjustment body 10 on the second base component B2 is realized.

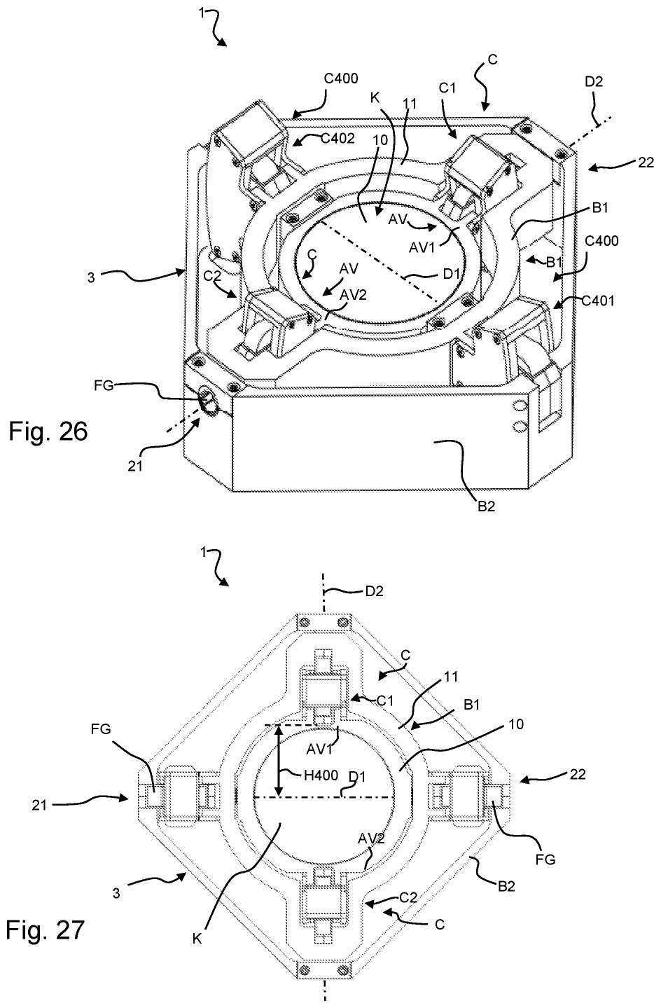

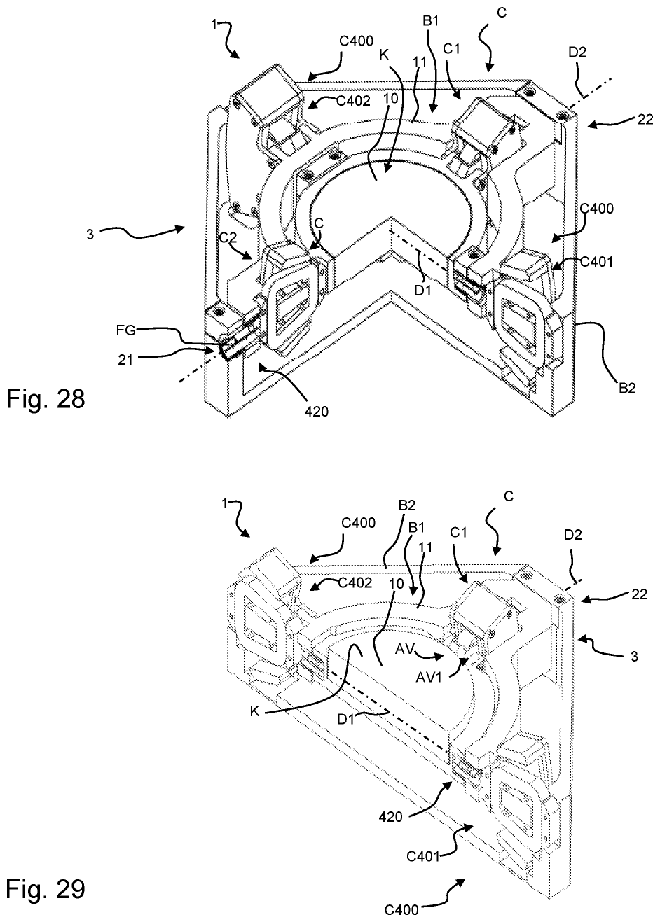

Such an embodiment of the adjustment device I is shown in FIGS. 26 to 29. The second base component B2 is coupled to the first base component B1 by means of a drive device C400 on sides of the second base component B2 which are lying opposite to one another with respect to the base component rotation axis D2, wherein the drive device C400 can be designed according to one of the variants of the drive device described herein according to FIGS. 1 to 25. In each of these variants, however, the flexure hinge rotation axis D1 can be replaced by the base component rotation axis D2.

In particular, in this embodiment of the drive device C400, which is coupled to the base component B1 and the second base component B2, the same is situated at a distance H400 from the base component rotation axis D2, so that an actuating movement of the drive device C causes a rotation of the second base component B2 about the base component rotation axis D2, wherein the drive device C400 comprises:

an actor 60 which comprises an electrical coil 71, the coil axis AS of which runs along the base component rotation axis D2, and which comprises a compensation component 80, which is formed from a hard-magnetic or a soft-magnetic material and which is arranged outside a section of the coil 71, wherein the compensation component 80 and the coil 71 are mechanically fixed relative to one another,

at least one permanent magnet segment MS, wherein the permanent magnet segment MS is arranged at a contactless distance beside the coil 71 which distance runs in the direction of the coil axis AS, wherein a permanent magnet segment MS of the at least one permanent magnet segment MS at least partially overlaps a portion of the coil 71 at least in a movement region of the at least one permanent magnet segment MS relative to the actor 60, as seen in the coil axis AS, wherein the mounting of the drive device C on the adjustment device 1 is provided for carrying out an adjustment movement according to one of the two alternatives (a), (b):
(a) the actuator 60 is coupled to the base component B1 and the permanent magnet segment MS is coupled to the adjustment body connection device AV,
(b) the actuator 60 is coupled to the adjustment body connection device AV and the permanent magnet segment MS is coupled to the base component B1.

In these embodiments of the adjustment device 1, the actuator 60 can be designed according to one of the variants described herein. The drive device C can also be embodied according to one of the variants described herein and can be embodied in particular with a plurality of permanent magnet segments MS as described herein.

### REFERENCE NUMERALS

1 adjustment device

3 adjustment body housing

10 adjustment body

11 adjustment body frame

15 pivot bearing retainer

16 pivot bearing retainer

20 flexure hinge device

21 first flexure hinge

22 second flexure hinge

25 adjustment body adjustment section

26 adjustment body adjustment section

27 adjustment body adjustment section

28 adjustment body adjustment section

53 magnet segment support

54 magnet segment support

55 gap

56 gap

57 connection piece

58 connection piece

60 actor

63 fastening part

64 fastening part

65 connection element

67 recess

68 recess

70 coil device

71 electrical coil

72 coil housing

75 first coil section

76 second coil section.

80 compensation component

81 polarization area.

82 polarization area

110 compensation component

111 surface

113 surface portion

114 surface portion

115 line

120 compensation component

121 surface e

123 surface portion

124 surface portion

125 line

380 compensation element

381 lateral surface

382 lateral surface

390 compensation element

391 lateral surface

392 lateral surface

420 flexure hinge device

AS coil axis

AV adjustment body connection device

B1 base component

B2 second base component

C drive device

C1 drive device

C2 drive device

C400 drive device

C401 drive device

C402 drive device

D1 adjustment body rotation axis

D2 base component rotation axis

FG axle component

H distance

MS permanent magnet segment

MS11 permanent magnet segment

MS12 permanent magnet segment

MS21 permanent magnet segment

MS22 permanent magnet segment

R81 magnetic field line direction of the polarization area 81

R82 magnetic field line direction of the polarization area 82

R380 compensation element magnetic field line

R390 compensation element magnetic field line

RMS11 magnetic field line of the permanent magnet segment MS11

RMS12 magnetic field line of the permanent magnet segment MS12

RMS21 magnetic field line of the permanent magnet segment MS21

RMS22 magnetic field line of the permanent magnet segment MS22

Z centre of the adjustment body 10

1-21. (canceled)

22. An actuating device comprising:
a base component, an actuating body, at least one solid body joint, by means of which the adjusting body is rotatably mounted on the base component about a solid body joint axis of rotation, and at least one drive device, which is coupled to the base component and to an actuator connection device and which is situated at a distance from the solid body joint axis of rotation such that an adjustment movement of the drive device causes rotation of the actuator about the actuator axis of rotation (D1;
wherein the drive device comprising:
an actuator including an electrical coil including a coil axis extending along the solid-state joint axis of rotation, and a compensation member having a magnetizable or magnetized material or consisting of such a material, wherein the compensation member and the coil are mechanically fixed relative to each other,
at least one permanent magnet segment, wherein the permanent magnet segment (MS) is situated next to the coil at a contactless distance in a direction running in the coil axis.

23. The actuating device according to claim 22 comprising:
a base component, an actuating body, at least one solid body joint, by means of which the adjusting body is rotatably mounted on the base component about a solid body joint axis of rotation, and at least one drive device, which is coupled to the base component and to an actuator connection device and which is situated at a distance from the solid body joint axis of rotation such that an adjustment movement of the drive device causes rotation of the actuator about the actuator axis of rotation;
the drive device comprising:
an actuator including an electrical coil, and having a compensation component which has a magnetizable or magnetized material or consists of such a material, wherein the compensation component and the coil are mechanically fixed relative to one another,
at least one permanent magnet segment, wherein the permanent magnet segment is situated next to the coil at a contactless distance in a direction running in the coil axis,
wherein, when a respective drive device is actuated, a relative movement between the coil and the permanent magnet segment is caused by a relative movement direction which runs transversely to a plane which is spanned by the solid body joint axis of rotation of the adjusting body and the actuator connection device on which the respective actuator is coupled.

24. The actuating device according to claim 1 wherein the actuating device has a second drive device, the first drive device is coupled to a first actuator connection device of the actuator body and the second drive device is coupled to a second actuator connection device of the actuator body, wherein the first actuator connection device and the second actuator connection device are symmetrically opposite with respect to the solid body joint axis of rotation.

25. The actuating device according to claim 23 wherein the actuating device has a second drive device, the first drive device is coupled to a first actuator connection device of the actuator body and the second drive device is coupled to a second actuator connection device of the actuator body, wherein the first actuator connection device and the second actuator connection device are symmetrically opposite with respect to the solid body joint axis of rotation.

26. The actuating device according to claim 22, wherein the adjusting device has a coil housing which is at least partially hollow-ring-shaped and in which the coil is arranged, wherein the circumferential direction of the coil runs along the circumferential direction of the coil housing.

27. The actuating device according to claim 26, wherein at least one compensation component, as seen in the coil axis, is arranged in the outer space surrounding the coil housing.

28. The actuating device according to claim 27, wherein the at least one compensation component is arranged in the outer space located outside the outer circumference of the coil housing as seen in the coil axis.

29. The actuating device according to claim 22, wherein the at least one drive device includes two permanent magnet segments which are fastened on a magnetic segment carrier, wherein the permanent magnet segments are situated on the same side of the actuator as seen from the actuating body axis of rotation and in the direction of the relative movement between the coil and permanent magnet segments are arranged one behind the other.

30. The actuating device according to claim 1, wherein the drive device has two pairs of permanent magnet segments, and a first pair of permanent magnet segments is arranged on a first magnetic segment carrier and a second pair of permanent magnet segments is arranged on a second magnetic segment carrier, wherein the pairs of permanent magnet segments are located on mutually different sides of the actuator as seen from the actuator axis of rotation.

31. The actuating device according to claim 29, wherein the at least one drive device includes at least one arrangement of two permanent magnet segments located on at least one side of the coil as seen from a center of the actuating body, and a compensation component includes at least one side surface which is situated facing an arrangement of the permanent magnet segments, wherein the side surface includes at least one part-surface portion, the orientation of which is at an angle between 10 degrees and 40 degrees.

32. The actuating device according to claim 22, wherein the actuating device has at least one or more of the sensors selected from the group consisting of:
a current meter detecting the current in the coil,
a rotation angle sensor which, in the solid-state joint device or in one of the solid-state joints, detects a rotation for determining a rotational movement of the actuator body with respect to the base component, and
a magnetic field sensor arranged in the actuator (60), which detects the thickness and the direction or the thickness or the direction of the magnetic field in the space surrounding the coil (71),
wherein the actuator comprises a data management device operatively connected to the one or more of the sensors the data management device comprising: an interface function with which signals detected by the at least one or more of the sensors are received and converted to storable sensor data and stored, and a transmission function with which the sensor data is transmitted to a receiving device of an evaluation device.

33. The actuating device according to claim 32 in combination with an evaluation device to form a control system, the control system comprising:
a reception function which receives the sensor data from the transmission function, an evaluation function which assigns an operating state value for the actuating device from the sensor data.

34. The control system according to claim 33, wherein the evaluation function has a maintenance function which compares a plurality of sensor data with at least one setpoint value and, if the setpoint value is exceeded or undershot, generates an operating state value.

35. The control system of claim 34, wherein the evaluation device comprises a display device operatively connected to the evaluation function and indicating the operating state value.

36. The control system according to 33, wherein the evaluation function determines at least one operating state value which indicates one or more of the following operating states of the actuating device on the display device:
the actuator is in normal operation;
the actuator is defective;
for the actuating device, a maintenance measure or safety check is due.

37. The control system according to claim 33, wherein the evaluation function has a simulation function with a mathematical model of the actuating device and with a transfer function, wherein the transfer function supplies a plurality of sensor data to the mathematical model and the mathematical model from the sensor data determines control state values of one or more of the following components:
the drive device, and
the actuator.

38. A computer program product comprising an evaluation function which assigns an operating state value for an actuating device from sensor data determined in the actuating device,
wherein the evaluation function has a simulation function with a mathematical model of an actuating device and with a transfer function, wherein the transfer function comprises a plurality of supplied sensor data to the mathematical model and the mathematical model from the sensor data determines control state values of one or more of the following components:
the drive device, and
the actuator; and
wherein the actuating device comprising:
a base component, an actuating body, at least one solid body joint, by means of which the adjusting body is rotatably mounted on the base component about a solid body joint axis of rotation, and at least one drive device, which is coupled to the base component and to an actuator connection device and which is situated at a distance from the solid body joint axis of rotation such that an adjustment movement of the drive device causes rotation of the actuator about the actuator axis of rotation (D 1
wherein the drive device comprising:
an actuator including an electrical coil including a coil axis extending along the solid-state joint axis of rotation, and a compensation member having a magnetizable or magnetized material or consisting of such a material, wherein the compensation member and the coil are mechanically fixed relative to each other,
at least one permanent magnet segment, wherein the permanent magnet segment (MS) is situated next to the coil at a contactless distance in a direction running in the coil axis.

39. A computer program product comprising a mathematical model of an actuating device, wherein the mathematical model of the actuating device determines control state values of one or more of the following components on the basis of at least one input value for an electrical input signal for the coil:
the drive device,
the actuator; and
wherein the actuating device comprising:
a base component, an actuating body, at least one solid body joint, by means of which the adjusting body is rotatably mounted on the base component about a solid body joint axis of rotation, and at least one drive device, which is coupled to the base component and to an actuator connection device and which is situated at a distance from the solid body joint axis of rotation such that an adjustment movement of the drive device causes rotation of the actuator about the actuator axis of rotation (D1;
wherein the drive device comprising:
an actuator including an electrical coil including a coil axis extending along the solid-state joint axis of rotation, and a compensation member having a magnetizable or magnetized material or consisting of such a material, wherein the compensation member and the coil are mechanically fixed relative to each other,
at least one permanent magnet segment, wherein the permanent magnet segment (IVIS) is situated next to the coil at a contactless distance in a direction running in the coil axis.

40. The computer program product according to claim 38, wherein the mathematical model of the actuator determines control state values of the actuator with the rotation of the actuator about the actuator axis of rotation relative to the base member with functional inclusion of the dynamic behavior of the solid-state joint due to actuation values of the drive device.

41. The computer program product according to claim 38, wherein the mathematical model of the actuating device has a drive device model which determines control state values of the drive device on the basis of at least one input value for an input signal for the coil.

42. The computer program product of claim 41, wherein the drive device model functionally defines the magnetic interaction of the coil, the compensation component, and the permanent magnet segment based on input values for an input signal for the coil.
